(19) United States
(12) Patent Application Publication
(10) Pub. No.: US 2012/0176423 A1
(43) Pub. Date: Jul. 12, 2012

(54) DISPLAY DEVICE AND LIGHT SOURCE DEVICE

(75) Inventors: Hitoshi NAGATO, Tokyo (JP); Takashi MIYAZAKI, Kanagawa-ken (JP); Yutaka NAKAI, Kanagawa-ken (JP); Tomio ONO, Kanagawa-ken (JP); Yoshinori HONGUH, Kanagawa-ken (JP); Hideki NUKADA, Kanagawa-ken (JP); Yuzo HIRAYAMA, Kanagawa-ken (JP); Hajime YAMAGUCHI, Kanagawa-ken (JP)

(73) Assignee: Kabushiki Kaisha Toshiba, Minato-ku (JP)

(21) Appl. No.: 13/423,376

(22) Filed: Mar. 19, 2012

(30) Foreign Application Priority Data
Jan. 7, 2010 (JP) PCT/JP10/00071

(51) Int. Cl. G09G 5/10; F21V 9/00

(52) U.S. Cl. 345/690; 362/231

(57) ABSTRACT

According to one embodiment, a display device includes an optical switch panel, and a light source device. The optical switch panel includes pixels and a drive part controlling transmissivity of the pixels. The light source device is stacked with the panel and includes a light source to emit a source light, a light guiding unit, interference filters, and light controlling parts. The light guiding unit includes a light guide region guiding the source light, a reflecting part provided around the region to reflect the source light, and apertures provided around the region and causing semi-collimated light to be emitted. The interference filters cause lights in certain wavelength dands of the light emitted from the aperture to pass. The light controlling parts cause the lights through the filters to enter the pixels to form an image.

### CROSS-REFERENCE TO RELATED APPLICATIONS

This is a continuation application of International Application PCT/JP2010/000071, filed on Jan. 7, 2010; the entire contents of which are incorporated herein by reference.

### FIELD

Embodiments described herein relate generally to a display device and a light source device.

### BACKGROUND

When color display is performed in a display device such as a liquid crystal display device, the configuration in which an absorption filter absorbing a specific wavelength is provided for each of pixels prevails, but, in this case, the light utilization efficiency is lowered due to the light absorption by the absorption filter, to increase power consumption.

In contrast, the configuration in which a nonabsorbent interference filter is provided is proposed. For example, JP 2-214287 A (Kokai) proposes an illumination apparatus for a display device, in which uncollimated light is caused to enter a small lens from a slot of a light box via an interference filter and semi-collimated light is supplied from the small lens. However, there is a room of an improvement for enhancing further the efficiency.

### BRIEF DESCRIPTION OF THE DRAWINGS

FIG. 1 is a schematic cross-sectional view illustrating the configuration of a display device;

FIGS. 2A, 2B and 2C are schematic views illustrating properties of the light source device;

FIG. 3 is a schematic view illustrating the operation of a display device;

FIGS. 4A and 4B are schematic views illustrating properties of the display device;

FIG. 5 is a schematic view showing properties of a display device of a comparative example;

FIG. 6 is a schematic view illustrating properties of a display device of a comparative example;

FIGS. 7A and 7B are schematic views illustrating properties of a display device of a comparative example;

FIGS. 8A and 8B are schematic views illustrating properties of display devices of comparative examples;

FIG. 9 is a schematic cross-sectional view illustrating the configuration of a display device;

FIG. 10 is a schematic cross-sectional view illustrating the configuration of a display device;

FIG. 11 is a schematic cross-sectional view illustrating the configuration of a display device;

FIG. 12 is a schematic cross-sectional view illustrating the configuration of a display device;

FIG. 13 is a schematic cross-sectional view illustrating the configuration of a display device;

FIG. 14 is a schematic cross-sectional view illustrating the configuration of a display device;

FIG. 15 is a schematic cross-sectional view illustrating the configuration of a display device; and

FIG. 16 is a schematic cross-sectional view illustrating the configuration of a display device.

### DETAILED DESCRIPTION

According to one embodiment, a display device includes an optical switch panel, and a light source device. The optical switch panel includes a first pixel, a second pixel juxtaposed with the first pixel, a drive part to control transmissivity of the first pixel with respect to a light entering the first pixel and transmissivity of the second pixel with respect to a light entering the second pixel. The light source device is stacked with the optical switch panel. The light source device includes a light source to emit a source light, a light guiding unit, a first interference filter, a first light controlling part, a second interference filter, and a second light controlling part. The light guiding unit includes a light guide region to guide the source light, a reflecting part provided around the light guide region to reflect the source light toward the light guide region, a first aperture provided around the light guide region and causing a first light based on the source light to be emitted toward outside of the light guide region, the first light being semi-collimated, and a second aperture provided around the light guide region and causing a second light based on the source light to be emitted toward the outside of the light guide region, the second light being semi-collimated. The first interference filter causes a light in a first wavelength dand of the first light emitted from the first aperture to pass the first interference filter. Transmittance of the light in the first wavelength dand through the first interference filter is higher than transmittance of a light in a wavelength dand excluding the first wavelength dand. Reflectance of the light in the first wavelength dand of the first interference filter is lower than reflectance of the light in the wavelength dand excluding the first wavelength dand. The first light controlling part causes the light passed through the first interference filter to enter the first pixel to form an image. The second interference filter causes a light in a second wavelength dand of the second light emitted from the second aperture to pass the second interference filter. The second wavelength dand is different from the first wavelength dand. Transmittance of the light in the second wavelength dand through the second interference filter is higher than transmittance of a light in a wavelength dand excluding the second wavelength dand. Reflectance of the light in the second wavelength dand of the second interference filter is lower than reflectance of the light in the wavelength dand excluding the second wavelength dand. The second light controlling part causes the light passed through the second interference filter to enter the second pixel to form an image.

According to another embodiment, a light source device includes a light source to emit a source light, a light guiding unit, a first interference filter, a first light controlling part, a second interference filter, and a second light controlling part. The light guiding unit includes a light guide region to guide the source light, a reflecting part provided around the light guide region to reflect the source light toward the light guide region, a first aperture provided around the light guide region and causing a first light based on the source light to be emitted toward outside of the light guide region, the first light being semi-collimated, and a second aperture provided around the light guide region and causing a second light based on the source light to be emitted toward the outside of the light guide region, the second light being semi-collimated. The first interference filter causes a light in a first wavelength dand of the first light emitted from the first aperture to pass the first interference filter. Transmittance of the light in the first wavelength dand through the first interference filter is higher than transmittance of a light in a wavelength dand excluding the first wavelength dand. Reflectance of the light in the first wavelength dand of the first interference filter is lower than reflectance of the light in the wavelength dand excluding the first wavelength dand. The first light controlling part causes the light passed through the first interference filter to form an image. The second interference filter causes a light in a second wavelength of the second light emitted from the second aperture to pass the second interference filter. The second wavelength dand is different from the first wavelength dand. Transmittance of the light in the second wavelength dand through the second interference filter is higher than transmittance of a light in a wavelength dand excluding the second wavelength dand. Reflectance of the light in the second wavelength dand of the second interference filter is lower than reflectance of the light in the wavelength dand excluding the second wavelength dand. The second light controlling part causes the light passed through the second interference filter to form an image.

Various embodiments will be described hereinafter with reference to the accompanying drawings.

The drawings are schematic or conceptional; and the relationship between the thicknesses and widths of portions, the proportions of sizes among portions, etc., are not necessarily the same as the actual values thereof. Further, the dimensions and the proportions may be illustrated differently among the drawings, even for identical portions.

In the specification and the drawings of the application, components similar to those described in regard to a drawing thereinabove are marked with like reference numerals, and a detailed description is omitted as appropriate.

### First Embodiment

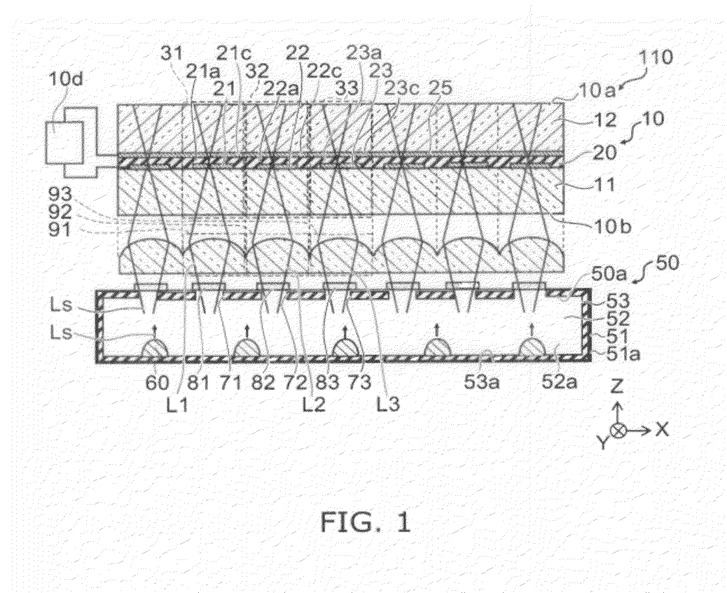

FIG. 1 is a schematic cross-sectional view illustrating the configuration of a display device according to a first embodiment of the invention.

As shown in FIG. 1, a display device 110 according to the first embodiment of the invention is provided with an optical switch panel 10 and a light source device 50.

The light source device 50 is provided on the side of a rear face 10b of the optical switch panel. The display device 110 is viewed visually from the side of a front face 10a of the optical switch panel 10.

Here, the direction going from the light source device 50 to the optical switch panel 10 is defined as a Z-axis direction (a first direction). One direction perpendicular to the Z-axis direction is defined as an X-axis direction (a second direction). The direction perpendicular to the Z-axis direction and the X-axis direction is defined as a Y-axis direction (a third direction).

The optical switch panel 10 has a first pixel 31, a second pixel 32 juxtaposed with the first pixel 31, and a drive part 10d controlling the transmissivity of the first pixel 31 for light entering the first pixel 31 and the transmissivity of the second pixel 32 for light entering the second pixel 32. The drive part 10d includes, for example, a signal-generating circuit etc. provided on the optical switch panel 10.

The light source device 50 has a light source 60, a light guiding unit 51, a first interference filter 81, a first light controlling part 91, a second interference filter 82, and a second light controlling part 92.

The light source 60 emits a source light Ls. The light guiding unit 51 has a light guiding region 52, a reflecting part 53, a first aperture 71, and a second aperture 72.

The light guiding region 52 guides the source light Ls. The reflecting part 53 is provided around the light guiding region 52 and reflects the source light Ls toward the light guiding region 52.

The first aperture 71 is provided around the light guiding region 52, and causes a semi-collimated light based on the source light Ls (a first light) to be emitted toward the outside of the light guiding region 52. The first aperture 71 faces the first pixel 31 along the Z-axis direction.

The second aperture 72 is provided around the light guiding region 52, and causes semi-collimated light based on the source light Ls (a second light) to be emitted toward the outside of the light guiding region 52. The second aperture 72 faces the second pixel 32 along the Z-axis direction. For example, the second aperture 72 is disposed adjacent to the first aperture 71 along the X-axis direction.

The light guiding unit 51 has a major surface 50a on which the first aperture 71 and the second aperture 72 are provided.

In the specific example, the light guiding unit 51 has a casing 51a having a cavity 52a in the inside, and the light guiding region 52 includes a region of the cavity 52a. And the light source 60 is provided inside the casing 51a. The reflecting part 53 is provided along an inner wall 53a surrounding the cavity 52a. Meanwhile, the reflecting part 53 may be a reflection film provided along the inner wall 53a of the casing 51a, or may be the inner wall 53a itself of the casing 51a.

The first interference filter 81 causes the light in a first wavelength dand (a first light L1) of the light emitted from the first aperture 71 (the first light) to pass. The first interference filter 81 reflects lights in wavelength dands excluding the first wavelength dand. The transmittance of the first interference filter 81 to the light in the first wavelength dand is higher than the transmittance to lights in wavelength dands excluding the first wavelength dand, and the reflectance of the first interference filter 81 to the light in the first wavelength dand is lower than the reflectance to lights in wavelength dands excluding the first wavelength dand. The light reflected by the first interference filter 81 goes toward the light guiding region 52.

The first light controlling part 91 causes the light passed through the first interference filter 81 (the first light L1) to form an image and causes the light to enter the first pixel 31. The first light controlling part 91 is provided between the first interference filter 81 and the first pixel 31.

The second interference filter 82 causes the light in the second wavelength dand (a second light L2) of the light emitted from the second aperture 72 (the second light) to pass. The second wavelength dand is a wavelength dand different from the first wavelength dand. The second interference filter 82 reflects lights in wavelength dands excluding the second wavelength dand. The transmittance of the second interference filter 82 to the light in the second wavelength dand is higher than the transmittance to the light in wavelength dands excluding the second wavelength dand, and the reflectance of the second interference filter 82 to the light in the second wavelength dand is lower than the reflectance to lights in wavelength dands excluding the second wavelength dand. The light reflected from the second interference filter 82 goes toward the light guiding region 52.

The second light controlling part 92 causes the light passed through the second interference filter 82 (the second light L2) to form an image and causes the light to enter the second pixel 32. The second light controlling part 92 is provided between the second interference filter 82 and the second pixel 32.

As the light source 60 provided inside the casing 51a of the light source device 50, for example, a directional LED or the like is used. In the specific example, the casing 51a surrounds the light source 60.

For the inner wall 53a of the casing 51a, the reflecting part 53 with high reflectance is provided. On a part of the wall face of the casing 51a, the first aperture 71 and the second aperture 72 are provided. The first interference filter 81 and the second interference filter 82 provided in the first aperture 71 and the second aperture 72 are unabsorbing color filters. In the specific example, for first light controlling part 91 and the second light controlling part 92, a lens array is used.

The light emitted from the first aperture 71 passes through the first interference filter 81 to become the first light L1, and the first light L1 is caused to form an image, for example, in a region near a first liquid crystal layer 21a by the first light controlling part 91. The second light L2 and third light L3 are caused to form an image in the same manner in a region near a second liquid crystal layer 22a and a third liquid crystal layer 23a.

In the display device 110 having such configuration, by using interference filters (the first interference filter 81 and the second interference filter 82), lights in wavelength dands excluding the wavelength dand of the light passing through the interference filter are reflected by the interference filter and pass through an interference filter of another color. The utilization of light without being absorbed improves the light utilization efficiency. And, the provision of light controlling parts (the first light controlling part 91 and the second light controlling part 92) between interference filters (the first interference filter 81 and the second interference filter 82) and pixels (the first pixel 31 and the second pixel 32), respectively, allows light reflected by the interference filter to enter directly the light guiding region 52, thereby suppressing the absorption of the light. This will be described later.

Furthermore, in the display device 110, since the light emitted from apertures (the first aperture 71 and the second aperture 72) is formed into a semi-collimated light, and light controlling parts (the first light controlling part 91 and the second light controlling part 92) cause the light to form an image, the light emitted from each of the apertures enters an intended pixel and entering other pixels (adjacent pixels) can be suppressed, even when apertures (the first aperture 71 and the second aperture 72) are made large. As the result, it is possible to suppress color mixture, to make the aperture large, and to improve the light utilization efficiency.

In this way, according to the display device 110, a display device with high efficiency and low power consumption can be obtained. Such properties in the display device 110 will be described later.

In the display device 110 according to the embodiment, the optical switch panel 10 further has a third pixel 33 juxtaposed with the first pixel 31 and the second pixel 32. The third pixel 33 is disposed, for example, adjacent to the second pixel 32 on the side of the second pixel 32 opposite to the first pixel 31 along the X-axis direction. The drive part 10d furthermore controls the transmissivity of the third pixel 33 to light entering the third pixel 33.

The light guiding unit 51 further has a third aperture 73. The third aperture 73 is provided around the light guiding region 52, and causes a semi-collimated light based on the source light Ls (a third light) to be emitted toward the outside of the light guiding region 52. The third aperture 73 faces the third pixel 33 along the Z-axis direction. That is, the third aperture 73 is disposed, for example, adjacent to the second aperture 72 on the side of the second aperture 72 opposite to the first aperture 71 along the X-axis direction.

The light source device 50 further has a third interference filter 83 and a third light controlling part 93.

The third interference filter 83 causes the light in a third wavelength dand (a third light L3) of the light emitted from the third aperture 73 (a third light) to pass. The third wavelength dand is a wavelength dand different from the first wavelength dand and also different from the second wavelength dand. The third interference filter 83 reflects the light in wavelength dands excluding the third wavelength dand. The transmittance of the third interference filter 83 to the light in the third wavelength dand is higher than the transmittance to lights in wavelength dands excluding the third wavelength dand, and the reflectance of the third interference filter 83 to the light in the third wavelength dand is lower than the reflectance to the light in wavelength dands excluding the third wavelength dand. The light reflected from the third interference filter 83 proceeds toward the light guiding region 52.

The third light controlling part 93 causes the light passed through the third interference filter 83 (the third light L3) to form an image and causes the light to enter the third pixel 33. The third light controlling part 93 is provided between the third interference filter 83 and the third pixel 33.

In this way, in the specific example, on a part of the wall face of the casing 51a, the first to third apertures 71 to 73 are provided. The first to third interference filters 81 to 83 provided in the first to third apertures 71 to 73 are unabsorbing color filters. A lens array is used for the first to third lights flux-controlling first to third apertures 91 to 93.

The first wavelength dand is, for example, a red wavelength dand, the second wavelength dand is a green wavelength dand, and the third wavelength dand is a blue wavelength dand.

That is, the first interference filter 81 causes a red light to pass and reflects lights of colors excluding red. The second interference filter 82 causes a green light to pass and reflects light of colors excluding green. The third interference filter 83 causes a blue light to pass and reflects light of colors excluding blue.

For example, the green light reflected by the first interference filter 81 is reflected by the reflecting part 53 and enters the second interference filter 82 to be utilized as the second light L2. The blue light reflected by the first interference filter 81 is reflected by the reflecting part 53 and enters the third interference filter 83 to be utilized as the third light L3.

For example, the red light reflected by the second interference filter 82 is reflected by the reflecting part 53 and enters the first interference filter 81 to be utilized as the first light L1. The blue light reflected by the second interference filter 82 is reflected by the reflecting part 53 and enters the third interference filter 83 to be utilized as the third light L3.

For example, the red light reflected by the third interference filter 83 is reflected by the reflecting part 53 and enters the first interference filter 81 to be utilized as the first light L1. The green light reflected by the third interference filter 83 is reflected by the reflecting part 53 and enters the second interference filter 82 to be utilized as the second light L2.

In this way, by using the first to third interference filters 81 to 83, lights of all wavelengths are used effectively and are emitted toward the optical switch panel 10.

The optical switch panel 10 is, for example, a liquid crystal panel. The optical switch panel 10 has a first substrate 11, a second substrate 12, and a liquid crystal layer 20 provided between the first substrate 11 and the second substrate 12.

Specifically, the first pixel 31 has a first pixel electrode 21, a first opposing electrode 21c, and a first liquid crystal layer 21a provided between the first pixel electrode 21 and the first opposing electrode 21c. The second pixel 32 has a second pixel electrode 22, a second opposing electrode 22c, and a second liquid crystal layer 22a provided between the second pixel electrode 22 and the second opposing electrode 22c. The third pixel 33 has a third pixel electrode 23, a third opposing electrode 23c, and a third liquid crystal layer 23a provided between the third pixel electrode 23 and the third opposing electrode 23c.

In the specific example, the first to third pixel electrodes 21 to 23 are provided on the first substrate 11, and the first to third opposing electrodes 21c to 23c are provided on the second substrate 12, but the first to third pixel electrodes 21 to 23 may be provided on the second substrate 12, and the first to third opposing electrode 21c to 23c may be provided on the first substrate 11.

The first substrate 11 is, for example, an active matrix substrate, and each of the first to third pixel electrodes 21 to 23 is connected to a thin film transistor (not shown). The first to third opposing electrodes 21c to 23c are continuous electrode 25. For the first to third pixel electrodes 21 to 23 and for the first to third opposing electrodes 21c to 23c, a transparent electroconductive material having light-transmitting properties is used.

The first to third liquid crystal layers 21a to 23a are a continuous liquid crystal layer 20. The first to third liquid crystal layers 21a to 23a have, for example, a liquid crystal alignment of a twisted nematic (TN) type. The optical switch panel 10 is of a liquid crystal mode of a TN mode. However, the invention is not limited to this. The alignment of the liquid crystal in the first to third liquid crystal layers 21a to 23a is arbitrary, and, various display modes such as an OCB mode and an in-plane switching mode can be applied to the optical switch panel 10. For example, in the case of in-plane switching mode, the first to third pixel electrodes 21 to 23 and the first to third opposing electrodes 21c to 23c are provided on the same substrate (the first substrate 11 or the second substrate 12).

By applying an intended voltage to the first to third pixel electrodes 21 to 23, the alignment of the liquid crystal in the first to third liquid crystal layers 21a to 23a is changed, and, with the change of the alignment of the liquid crystal, the optical properties (such as birefringence, optical rotation, absorption, and/or scattering) of the first to third pixels 31 to 33 change. For example, on the side of the first substrate 11 opposite to the liquid crystal layer 20, and on the side of the second substrate 12 opposite to the liquid crystal layer 20, a polarizing sheet (a polarizing filter) and, if necessary, an optical compensating sheet etc. (not shown) are provided, respectively. Based on the change of optical properties of the first to third pixels 31 to 33, the transmissivity to lights entering the first to third pixels 31 to 33 changes.

That is, the drive part 10d controls the potential difference between the first to third pixel electrodes 21 to 23 and the first to third opposing electrodes 21c to 23c (the opposing electrode 25) via various wirings, thin film transistors or the like, controls the voltage applied to the first to third liquid crystal layers 21a to 23a, and controls the transmissivity of the first to third pixels 31 to 33.

The first pixel 31 can include, for example, the first pixel electrode 21, the first opposing electrode 21c and the first liquid crystal layer 21a, and the polarizing sheet (and a liquid crystal alignment layer etc.) accompanying these, but, since what changes in an optical switch operation in the first pixel 31 is the first liquid crystal layer 21a, the first pixel 31 can be considered as the first liquid crystal layer 21a, in the operation of the display device 110.

That is, positions of the first to third pixels 31 to 33 in the Z-axis direction may be set to be positions of the first to third liquid crystal layers 21a to 23a in the Z-axis direction.

In contrast, the first pixel 31 and the second pixel 32 are adjacent to each other along the X-axis direction, and the boundary between the first pixel 31 and the second pixel 32 can be set so as to correspond to the middle point of the first pixel electrode 21 and the second pixel electrode 22 in the X-axis direction. In the same manner, the second pixel 32 and the third pixel 33 are adjacent to each other along the X-axis direction, and the boundary between the second pixel 32 and the third pixel 33 can be set so as to correspond to the middle point of the second pixel electrode 22 and the third pixel electrode 23 in the X-axis direction. Moreover, the first to third pixels 31 to 33 are disposed repeatedly, the third pixel 33 and first pixel 31 are adjacent to each other along the X-axis direction, and the boundary between the third pixel 33 and the first pixel 31 can be set so as to correspond to the middle point of the third pixel electrode 23 and the first pixel electrode 21 in the X-axis direction.

Meanwhile, as described previously, the first to third liquid crystal layers 21a to 23a are mutually continuous along the X-axis direction (in an X-Y plane). The first to third liquid crystal layers 21a to 23a are a part of the liquid crystal layer 20, and the first to third liquid crystal layers 21a to 23a are set to be parts facing the first to third pixel electrodes 21 to 23, respectively, among the liquid crystal layer 20.

The optical switch panel 10 may further have a light-shielding film (a black matrix) having aperture regions corresponding to each of the first to third pixel electrodes 21 to 23. In this case, the center of edges of aperture regions corresponding, respectively, to the first to third pixel electrodes 21 to 23 can be set to the boundary of respective pixels. For example, the boundary of the first pixel 31 and the second pixel 32 can considered to be the center of the edge of the light-shielding film on the side of the first pixel electrode 21 and the edge of the light-shielding film on the side of the second pixel electrode 22.

As described previously, in the display device 110 according to the embodiment, lights emitted from the apertures (the first aperture 71, second aperture 72 and third aperture 73) are formed into a semi-collimated light. Hereinafter, properties regarding the spread of lights emitted from the first aperture 71, the second aperture 72 and the third aperture 73 will be explained. Since properties regarding the spread of lights emitted from the first aperture 71, the second aperture 72 and the third aperture 73 can be set to be substantially the same, explanation will given about the first aperture 71.

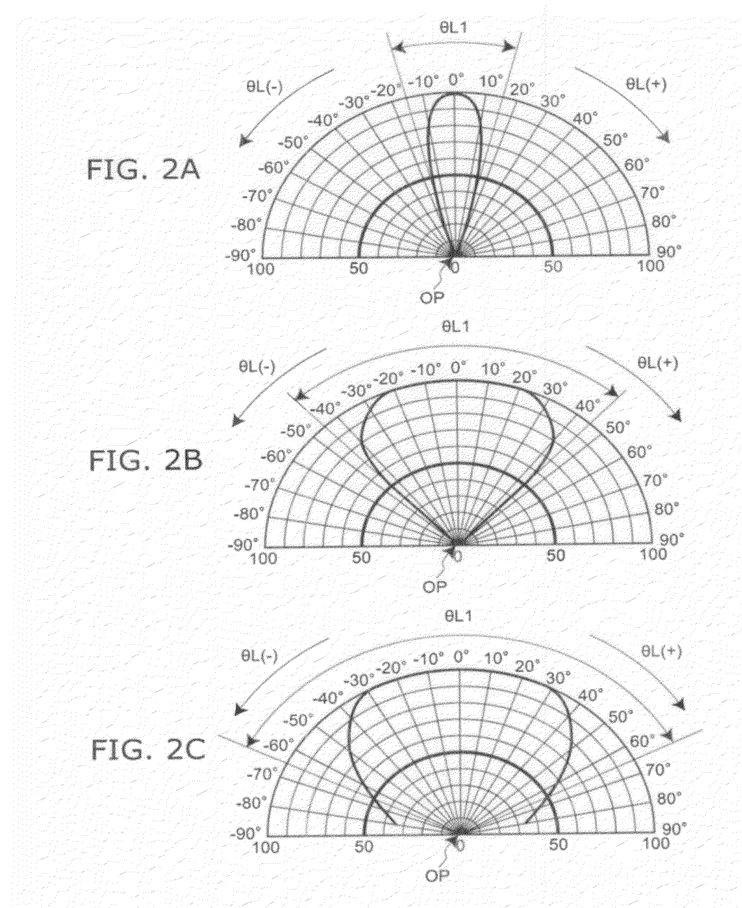

FIGS. 2A, 2B and 2C are schematic views illustrating properties of the light source device 50 for use in display devices.

That is, these drawings illustrate properties regarding the spread of the light emitted from the first aperture 71. In these drawings, the original point OP is the center of the first aperture 71, and radial axes show angles θL around the center of the first aperture 71. The front of the first aperture 71 corresponds to the case where the angle θL is 0 degree. In contrast, concentric arcs in these drawings relatively show intensities of light when the light intensity at the front of the first aperture 71 is set to be 100.

As shown in FIGS. 2A, 2B and 2C, here, as an indicator showing the spread of a light, an angle of spread θL1 is used. The angle of spread θL1 is defined as a range of angles in which values not less than half (for example, 50) of the maximum value (for example, 100) of the light intensity are obtained (the full width at half maximum), based on the direction in which the light intensity becomes maximum.

In the example shown in FIG. 2A, when an angle θL is 0°, the light intensity is maximum, and angles θL giving the light intensity of the half of the maximum value are +15° and −15°, and thus the angle of spread θL1 is 30°. In the example shown in FIG. 2B, when an angle θL is 0°, the light intensity is maximum, and angles θL giving the light intensity of the half of the maximum value are +45° and −45°, and thus the angle of spread θL1 is 90°. In the example shown in FIG. 2C, when an angle θL is 0°, the light intensity is maximum, and angles θL giving the light intensity of the half of the maximum value are +65° and −65°, and thus the angle of spread θL1 is 130°. The case where the angle of spread θL1 is 180° corresponds to an omnidirectional light, and, for example, the light intensity is the same at any angle.

In the description of the application, the case where the angle of spread θL1 is not more than 90° is defined as the semi-collimated light. And, the case where the angle of spread θL1 is more than 90° is defined as uncollimated light.

In the display device 110 according to the embodiment, lights emitted from the first aperture 71, the second aperture 72 and the third aperture 73 are defined as the semi-collimated light, and specifically, the angle of spread θL1 is set to be not more than 90°. In the display device 110, the angle of spread θL1 is more preferably not more than 60°. The angle of spread θL1 is further preferably not more than 40°. In this way, the spread of lights emitted from the first aperture 71, the second aperture 72 and the third aperture 73 is controlled to be narrow.

In order to control the spread of lights, for example, contrivances are applied to the light source 60. That is, as the light source 60, a directional LED having a limited angle of spread θL1, or the like is used. For example, when a directional LED having a high directivity, or the like is used as the light source 60, unevenness of intensity of light in the light guiding region 52 may be generated, but, by increasing the arrangement density of a plurality of directional LEDs and disposing a plurality of LEDs, the unevenness of the intensity of light can be suppressed.

Furthermore, by using a nonscattering reflective layer as the reflecting part 53, the spread of light may be controlled so as to be narrow. As the reflecting part 53, for example, a reflective layer of specular reflection can be used.

As the result, the spread of lights emitted from the first aperture 71, the second aperture 72 and the third aperture 73 can be controlled to be narrow.

By the first to third light controlling parts 91 to 93, the first to third lights L1 to L3 can be caused to form images, respectively, on the first to third liquid crystal layers 21a to 23a of the first to third pixels 31 to 33. If the angle of spread θL1 of lights emitted from the first to third apertures 71 to 73 is too large, the first to third lights L1 to L3 may protrude from each of the first to third light controlling parts 91 to 93, and the lights enter pixels of neighboring colors to generate color mixture. Therefore, the angle of spread θL1 of lights emitted from the first to third apertures 71 to 73 is desirably not more than a certain magnitude.

Hereinafter, first, properties for the reuse of light using the interference filter in the display device 110 according to the embodiment will be explained.

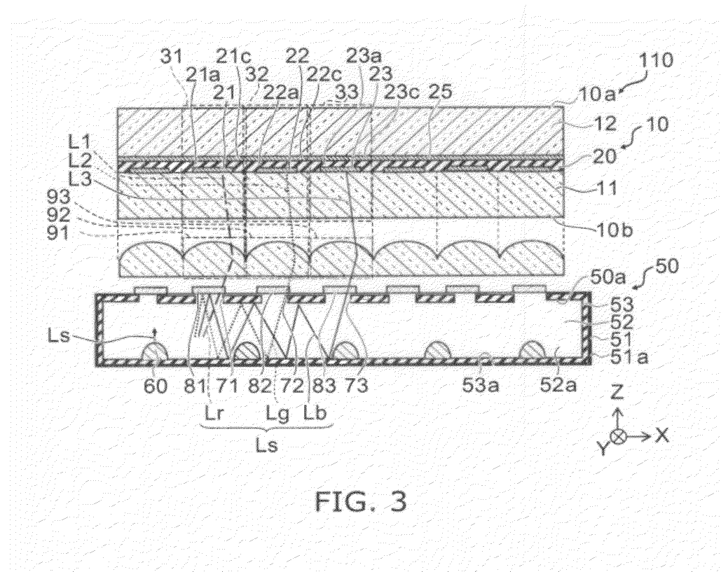

FIG. 3 is a schematic view illustrating the operation of a display device according to the first embodiment of the invention.

As shown in FIG. 3, for example, a red light Lr of a source light Ls passes through the first aperture 71 and enters the first red interference filter 81. A first red light L1 passed through the first interference filter 81 is caused to form an image on the first liquid crystal layer 21a by the first light controlling part 91. The first pixel 31 having the first liquid crystal layer 21a corresponds to a red pixel.

A green light Lg having entered the first interference filter 81 of the source light Ls is reflected by the first interference filter 81, is reflected by the reflecting part 53, and enters the second interference filter 82. A green second light L2 passed through the second interference filter 82 is caused to form an image on the second liquid crystal layer 22a by the second light controlling part 92. The second pixel 32 having the second liquid crystal layer 22a corresponds to a green pixel.

A blue light Lb having entered the first interference filter 81 of the source light Ls is reflected by the first interference filter 81, is reflected by the reflecting part 53, and enters the third interference filter 83. A blue third light L3 passed through the third interference filter 83 is caused to form an image on the third liquid crystal layer 23a by the third light controlling part 93. The third pixel 33 having the third liquid crystal layer 23a corresponds to a blue pixel.

That is, the red light Lr, the green light Lg and the blue light Lb of the source light Ls are reflected in a multiplexed manner, emitted from first to third interference filters 81 to 83 corresponding to respective colors, and enter respective pixels. As the result, in the display device 110, the light utilization efficiency is high, and thus power consumption can be reduced.

And, since the first to third lights L1 to L3 are controlled by the first to third light controlling parts 91 to 93, respectively, and are allowed to enter the first to third pixels 31 to 33, respectively, the color mixture is suppressed.

In this way, according to the display device 110 according to the embodiment, a display device capable of color display, in which the color mixture is suppressed and power consumption is low, can be provided.

### First Comparative Example

In a display device of a first comparative example, absorption type color filters are used. That is, for example, while facing the first to third pixel electrodes 21 to 23 of the first to third pixels 31 to 33, absorption type color filters, for example, of red, green and blue are provided, respectively. As the absorption type color filters, for example, those formed by mixing each pigment or dye of red, green and blue with a resin material are used. And, in the display device of the first comparative example, the first to third interference filters 81 to 83 and the first to third light controlling parts 91 to 93 (for example, a micro lens) are not provided.

In the display device of the first comparative example of such configuration, since light having a wavelength except for the wavelength of the light passing through the color filter are absorbed by the color filter, the light utilization efficiency is low. As the result, the power consumption is large.

### Second Comparative Example

In a display device of a second comparative example, an interference filter, in place of an absorption type color filter, is used. That is, in the same manner as the display device 110 according to the embodiment illustrated in FIG. 1, the light source device 50 has the first to third interference filters 81 to 83. However, in the display device in the second comparative example, the first to third light controlling parts 91 to 93 (for example, a micro lens) are not provided. Except for this, the display is the same as the display device 110 and explanation is omitted.

In the display device of the second comparative example, since the interference filter is used, the efficiency is high.

However, in the display device of the second comparative example, the light emitted from each of the first to third apertures 71 to 73 passes through the first to third interference filters 81 to 83, and, after that, enters the optical switch panel 10 via no optical device having an imaging effect (for example, a micro lens) such as the first to third light controlling parts 91 to 93. As the result, the color mixture is easily generated.

That is, even when the lights emitted from the first to third apertures 71 to 73 are controlled so as to give a small spread, in the case where no optical device having an imaging effect is used, the light emitted from the first to third interference filters 81 to 83 spreads larger than each width of the first to third pixels 31 to 33 before entering the first to third liquid crystal layers 21a to 23a of the first to third pixels 31 to 33. As the result, even in the case where the directivity of the first to third lights L1 to L3 emitted from the first to third interference filters 81 to 83 is controlled to the narrowest level in practical use, the light enters other neighboring pixels to generate the color mixture, thereby making it difficult to obtain an image of intended high grade.

In contrast, in the display device 110 according to the embodiment, by using the first to third light controlling parts 91 to 93, each of the first to third lights L1 to L3 emitted from the first to third interference filters 81 to 83 enters each of the first to third liquid crystal layers 21a to 23a of the first to third pixels 31 to 33, so as to form an image. As the result, the color mixture is suppressed, and an image with intended high grade can be obtained.

### Third Comparative Example

In a display device of a third comparative example, in the first to third apertures 71 to 73 of the light source device 50, the first to third light controlling parts 91 to 93 are provided, respectively, and the first to third interference filters 81 to 83 are provided on the side of the optical switch panel 10, instead of the side of the light source device 50. Specifically, the filters 81 to 83 are provided on the first substrate 11. Except for this, since the device is the same as the display device 110 according to the embodiment, the explanation is omitted.

In the display device of the third comparative example, since the first to third light controlling parts 91 to 93 are provided, the lights emitted from the first to third apertures 71 to 73 are caused to form an image on and enter the first to third interference filters 81 to 83, and the first to third liquid crystal layers 21a to 23a of the first to third pixels 31 to 33, respectively. Therefore, the generation of the color mixture is considered to be suppressed.

And, in the display device of the third comparative example, since the first to third interference filters are used, the loss caused by the absorption of the color filter is considered to be suppressed.

However, in the display device of the third comparative example, since the first to third interference filters 81 to 83 are provided at the optical switch panel 10, the loss of light is large.

For example, light passes through a boundary of different refractive indices after being emitted from the first aperture 71, being reflected by the first interference filter 81 and before returning to the first aperture 71. In the case of the third comparative example, the light passes through two boundaries of the first substrate 11 and two boundaries of the first light controlling part 91, total four boundaries. For example, when the transmittance of one boundary is set to 95%, the efficiency from the emission of light from the first aperture 71 to the return to the first aperture 71 is (0.95)⁴, that is, around 0.8.

Moreover, in consideration of the absorption in the first substrate 11 and the absorption in the first light controlling part 91, the efficiency further lowers.

In contrast, in the display device 110 according to the embodiment, since the first to third interference filters 81 to 83 are provided in the first to third apertures 71 to 73, respectively, the light reflected by the first to third interference filters 81 to 83 enters directly the light guiding region 52, and the loss as described above is not generated.

### Fourth Comparative Example

In a display device of a fourth comparative example, between the first to third interference filters 81 to 83 and the first to third apertures 71 to 73, respectively, the first to third light controlling parts 91 to 93 are provided. That is, in the fourth comparative example, positions of the first to third interference filters 81 to 83 and the first to third light controlling parts 91 to 93 on the light path are disposed in a direction opposite to positions in the display device 110 illustrated in FIG. 1. Except for this, the device is the same as the display device 110 according to the embodiment, and explanation is omitted.

In the display device of the fourth comparative example, lights emitted from the first to third apertures 71 to 73 enter the first to third light controlling parts 91 to 93, and then, enter the first to third interference filters 81 to 83, and each of the first to third lights L1 to L3 emitted from the first to third interference filters 81 to 83 enters each of the first to third liquid crystal layers 21a to 23a of the first to third pixels 31 to 33, so as to form an image. Therefore, the generation of color mixture is suppressed.

However, in the display device of the fourth comparative example, since the first to third light controlling parts 91 to 93 are provided between each of the first to third interference filters 81 to 83 and each of the first to third apertures 71 to 73, the loss of light is larger when compared with the display device 110 according to the embodiment.

In the display device of the fourth comparative example, the light passes through an interface having different refractive indices after being emitted from the first aperture 71, being reflected by the first interference filter 81, and before returning to the first aperture 71. That is, the light passes through two interfaces of the first light controlling part 91. For example, when assuming that the transmittance of one interface is 95%, the efficiency from the emission of the light from the first aperture 71 to the return to the first aperture 71 is (0.95)², that is, around 0.9.

In contrast, in the display device 110 of the embodiment, for example, since substantially no loss is generated after the light is emitted from the first aperture 71, reflected by the first interference filter 81, and before the light returns to the first aperture 71, the efficiency can be made higher than in the fourth comparative example. In this way, according to the display device 110 according to the embodiment, it is possible to provide a display device capable of performing color display of low power consumption with an improved efficiency, while suppressing the color mixture.

In the light source device 50 of the display device 110, a larger size of the first to third apertures 71 to 73 gives a more improved efficiency.

Here, the ratio of the size of the first to third apertures 71 to 73 relative to the size of the major surface 50a of the light source device 50 on which the first to third apertures 71 to 73 are provided is defined as an aperture ratio. Hereinafter, for simplicity, areas of the first to third apertures 71 to 73 is set to be the same one another.

And, the proportion of the total area of the first to third apertures 71 to 73 relative to the area of the major surface 50a of the light source device 50 on which the first to third apertures 71 to 73 are provided is defined as the aperture ratio. A case where the aperture ratio is 100% corresponds to a case where all of the major surface 50a are the first to third apertures 71 to 73. That is, the light guiding unit 51 has the major surface 50a on which the first aperture 71, the second aperture 72 and the third aperture 73 are provided. The ratio of the total area of the first aperture 71, the second aperture 72 and the third aperture 73 relative to the area of the major surface 50a is the aperture ratio.

The source light Ls emitted from the light source 60 is reflected by the reflecting part 53 of the light guiding unit 51, passes through the light guiding region 52, and is emitted from the first to third apertures 71 to 73. If the first to third apertures 71 to 73 are small (the aperture ratio is small), the lights to be emitted from the first to third apertures 71 to 73 are reflected many times by the reflecting part 53 and then emitted from the first to third apertures 71 to 73. Since the reflectance of the reflecting part 53 is not 1, as the number of reflections becomes larger, the intensity of the lights emitted from the first to third apertures 71 to 73 becomes smaller relative to the intensity of the source light Ls emitted from the light source 60. When the first to third apertures 71 to 73 are large (the aperture ratio is large), lights to be emitted from the first to third apertures 71 to 73 can be emitted from the first to third apertures 71 to 73 even when the reflection times by the reflecting part 53 are small. As the result, when the first to third apertures 71 to 73 are larger, the efficiency is more improved.

Accordingly, for practical purposes, it is effective to increase the aperture ratio of the first to third apertures 71 to 73 as much as possible, for improving the efficiency. In the display device 110, the aperture ratios of the first to third apertures 71 to 73 are set to be not less than 10%, more desirably, not less than 15%. Further desirably, the aperture ratios are set to be from 25% to 35%. From the viewpoint of the efficiency, a higher aperture ratio is better, but, from a practical viewpoint including the ease of fabrication of the light source device 50, the ratio is not more than about 60%. However, the invention is not limited to this, but the upper limit of the aperture ratio is arbitrary.

In the display device 110 according to the embodiment, by forming the lights emitted from the first to third apertures 71 to 73 into semi-collimated lights, and by causing the first to third controlling parts 91 to 93 to form images, aperture ratios of the first to third apertures 71 to 73 can be made high, thereby improving the efficiency. Hereinafter, the effect is described.

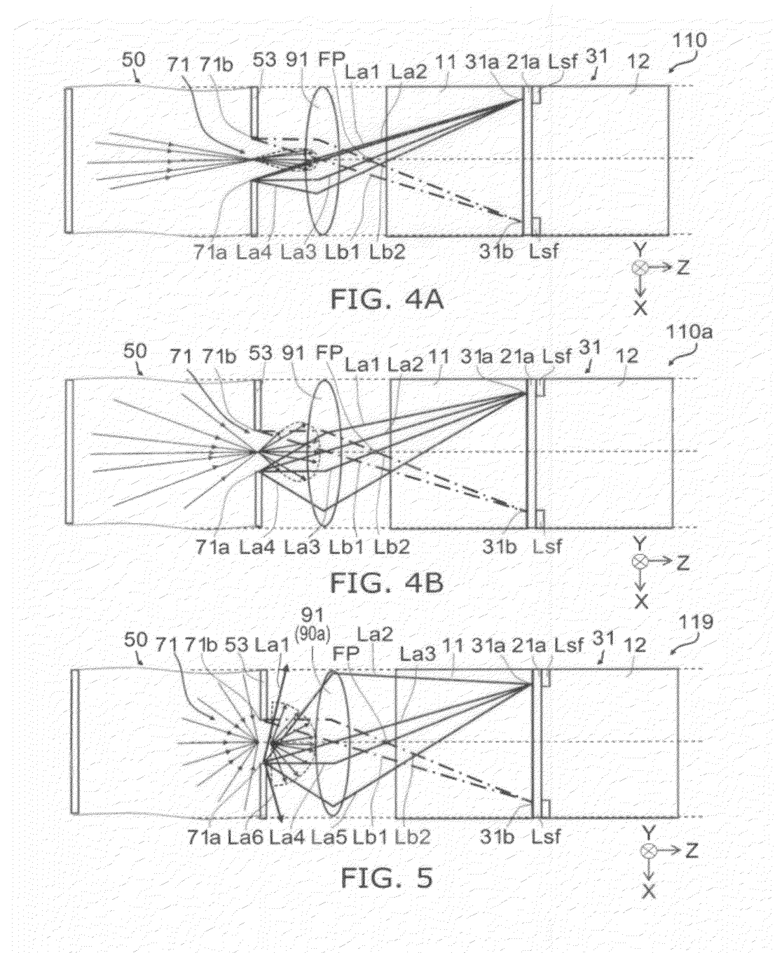

FIGS. 4A and 4B are schematic views illustrating properties of the display device according to the first embodiment of the invention.

That is, FIG. 4A illustrates properties of the display device 110 according to the embodiment, and FIG. 4B shows properties of another display device 110a according to the embodiment. In these drawings, the first aperture 71, the first interference filter 81 and the first light controlling part 91 will be explained, and the second and third apertures 72 and 73, the second and third interference filters 82 and 83, and the second and third light controlling parts 92 and 93 are the same. In these drawings, the first interference filter 81 is omitted. Moreover, these drawings show properties of light, and the shape etc. of each of configuration elements (such as the first light controlling part 91) are drawn in a modeled state. Furthermore, coordinate axes in these drawings are shown in a state rotated in 90° from coordinate axes in FIG. 1.

In the display device 110, the angle of spread θL1 of the light emitted from the first aperture 71 is 30°, in the display device 110a, the angle of spread θL1 of the light emitted from the first aperture 71 is 90°, and, in the display devices 110 and 110a, the light emitted from the first aperture 71 is a semi-collimated light. Moreover, the aperture ratio of the first aperture 71 is, for example, 30%.

As shown in FIG. 4A, in the display device 110, a light with the angle of spread θL1 of 30° is emitted from the first aperture 71, passes through the first interference filter 81 (not shown) to become the first light L1 and enters the first light controlling part 91. The first light controlling part 91 has imaging optical properties, and has a focal point FP. The first light controlling part 91 forms an image of the first aperture 71 on the first pixel 31.

Specifically, the light emitted from one end 71a of the first aperture 71 reaches, for example, through light paths such as light La1, light La1, light La3 and light La4, a certain point 31a of the first pixel 31. And, the light emitted from another end 71b of the first aperture 71 reaches, for example, through light paths such as the light Lb1 and the light Lb2, another point 31b of the first pixel 31. The points 31a and 31b are parts to be shielded by the light-shielding film Lsf of the first pixel 31.

In this way, in the display device 110, the light emitted from the first aperture 71 is caused to form an image in the region between the point 31a to the point 31b of the first pixel 31. And, the light passes through the first liquid crystal layer 21a of the first pixel 31, by which the light intensity is modulated to perform display. In this way, all the light emitted from the aperture 71 can enter the first pixel 31 to thereby give a high efficiency. This is because, in the display device 110, the angle of spread θL1 of the light emitted from the first aperture 71 is controlled to be as small as 30°, which is considered to be a semi-collimated light, and thus, the light emitted from the first aperture 71 appropriately enter the first light controlling part 91 and can be caused to form an image on the first pixel 31.

As shown in FIG. 4B, in the display device 110a, a light with a angle of spread θL1 of 90° is emitted from the first aperture 71, passes through the first interference filter 81 (not shown) to become the first light L1, and enters the first light controlling part 91. Also in the case, in the same manner as the display device 110, the first light controlling part 91 forms an image of the first aperture 71 on the first pixel 31.

In this way, also in the display device 110a, since all the light emitted from the aperture 71 can enter the first pixel 31, the efficiency is high. That is, in the display device 110a, although the angle of spread θL1 of the light emitted from the first aperture 71 is as large as 90°, the light is considered to be a semi-collimated light, and thus the light emitted from the first aperture 71 appropriately enters the first light controlling part 91 and can be caused to form an image on the first pixel 31.

In the display device 110a, since the angle of spread θL1 is large, as compared with the display device 110, the light emitted from the first aperture 71 passes through a broad range of the first light controlling part 91.

### Fifth Comparative Example

FIG. 5 is a schematic view showing properties of a display device of a fifth comparative example.

In a display device 119 of the fifth comparative example, the angle of spread θL1 of a light emitted from the aperture is as large as 130°, and the light emitted from the aperture is an uncollimated light.

As shown in FIG. 5, in the display device 119 of the fifth comparative example, since the angle of spread θL1 of the light emitted from the first aperture 71 is large and the spread of the light is large, a light La1 and a light La5 with a large emission angle pass the end of a lens 90a, and, a light La1 and a light La6 with a further large emission angle pass the outside of the lens 90a. In this way, in the display device 119, not all the light emitted from the first aperture 71 can enter the first light controlling part 91, and light with a large emission angle enters pixels other than the first pixel 31. As the result, the color mixture is generated.

In this way, when the angle of spread θL1 becomes too large, a part (light having an excessively large emission angle) of the light emitted from the first aperture 71 passes the outside of the range of the first light controlling part 91, for example, enters adjacent second and third light controlling parts 92 and 93, and is not caused to form an image on the first pixel 31.

In contrast, in the display device according to the embodiment, the angle of spread θL1 of the light emitting from the first aperture 71 is controlled to be not more than a certain value to be collimated. As the result, the light emitted from the first aperture 71 enters appropriately the first light controlling part 91, an image is formed on the first pixel 31, the color mixture is not generated, thereby being able to improve the efficiency.

### Sixth Comparative Example

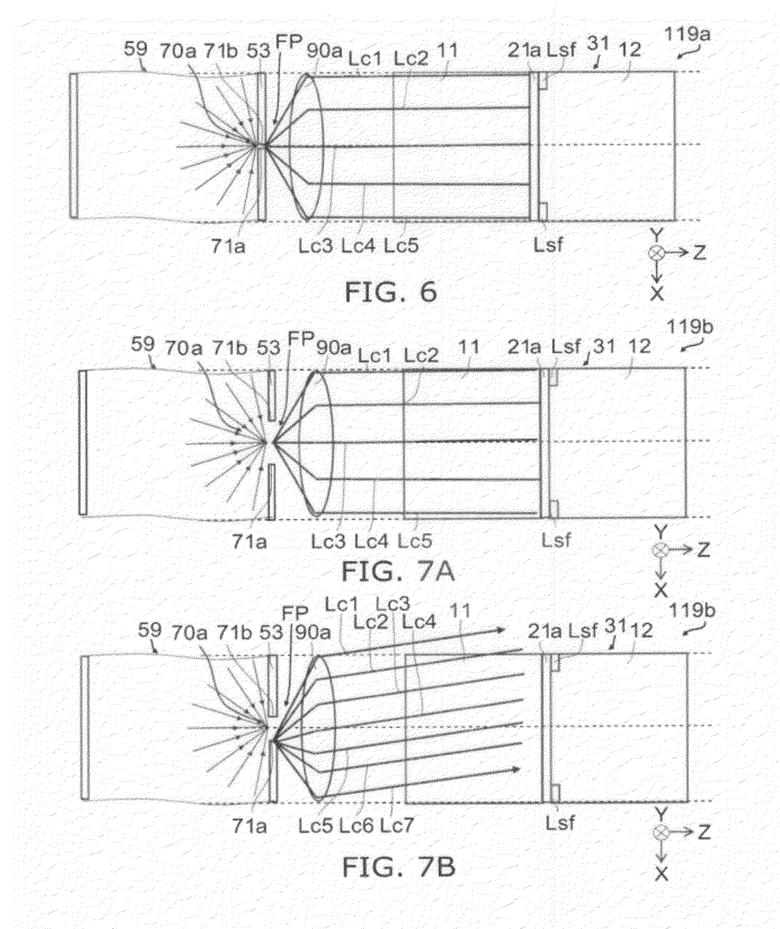

FIG. 6 is a schematic view illustrating properties of a display device of a sixth comparative example.

In a display device 119a of a sixth comparative example, the aperture 70a is small, and the reflecting part 53 is diffusion reflective. And, the spread (angle of spread θL1) of the light emitted from an aperture 70a is large, and the light is not collimated (for example, the angle of spread θL1 is 130°). And, the lens 90a is designed so as to convert the uncollimated light emitted from the small aperture 70a to a semi-collimated light. The aperture ratio of the aperture 70a is, for example, 2%. Also in this case, an interference filter (not shown) is disposed between the aperture 70a and the lens 90a. That is, in the display device 119a, a light source device 59 having a configuration similar to the configuration described in Patent Document 1 is used.

As shown in FIG. 6, the focal point FP of the lens 90a is disposed in the aperture 70a. In the display device 119a, uncollimated light emitted from the aperture 70a passes through the lens 90a enter, through light paths such as a light Lc1, a light Lc2, a light Lc3, a light Lc4 and a light Lc5, the first pixel 31. As the result, display is possible. However, in this case, since the size of the aperture 70a is small, the efficiency of the light source device 59 is considerably low.

That is, as described previously, when the size (the aperture ratio) of the aperture 70a is small, the number of the reflection times for the source light emitted from the light source in order to be emitted from the aperture 70a increases, and the efficiency is low.

### Seventh Comparative Example

FIGS. 7A and 7B are schematic views illustrating properties of a display device of a seventh comparative example.

A display device 119b of the seventh comparative example is a display formed by enlarging the aperture 70a in the light source device 59 in the display device 119a. In this case, the aperture ratio of the aperture 70a is 30%. And, such uncollimated light (for example, the angle of spread θL1 is 130°) emitted from the aperture 70a enters the lens 90a for collimating lights. FIG. 7A shows properties of the light passing through the center of the aperture 70a, and FIG. 7B shows properties of the light emitted from an end 71a of the aperture 70a.

As shown in FIG. 7A, the light passing through the center of the aperture 70a passes, in the same manner as the display device 119a when the aperture 70a is small, through the lens 90a and, through light paths such as the light Lc1, light Lc2, light Lc3, light Lc4 and light Lc5, enters the first pixel 31.

In contrast, as shown in FIG. 7B, the light emitted from the one end 71a of the aperture 70a is emitted through light paths such as the light Lc1, light Lc2, light Lc3, light Lc4, light Lc5, light Lc6 and light Lc7. Among these, the light Lc3, light Lc4, light Lc5, light Lc6 and light Lc7 enter the first pixel 31, but the light Lc1 and light Lc2 enter other pixels. As the result, the color mixture is generated.

In this way, in the case where the lens 90a with a property of collimation is used, when the aperture 70a is made large, a light emitted from one end 71a of the aperture 70a is emitted so as to be inclined in the minus direction of the X-axis direction, and the light emitted from another end 71b of the aperture 70a is emitted so as to be inclined in the plus direction of the X-axis direction, and thus the light emitted from the aperture 70a becomes not a collimated light but a spread light.

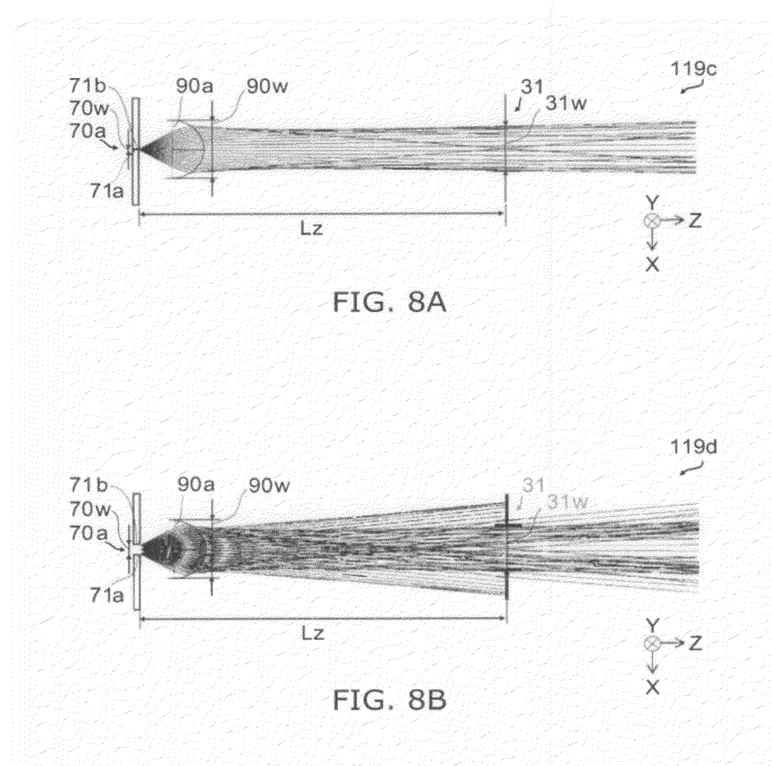

FIGS. 8A and 8B are schematic views illustrating properties of display device of comparative examples.

That is, FIGS. 8A and 8B illustrate properties of a display device 119c of an eighth comparative example, and a simulation result of properties of a display device 119d of a ninth comparative example. In the simulation, both a width 90w of the lens 90a (a width along the X-axis direction) and a width 31w of the first pixel 31 (a width along the X-axis direction) were set to be 200 μm (micrometers). In addition, a distance Lz from the aperture 70a to the first pixel 31 (a distance along the Z-axis direction) was set to be 900 μm.

FIG. 8A shows a result of simulation of a beam when a point light source having an angle of spread θL1 of 60° is disposed at the center of the aperture 70a. That is, the drawing corresponds to properties of the display device 119c of the eighth comparative example, wherein the aperture ratio of the aperture 70a is 0% (the width 70w of the aperture 70a is zero), and the angle of spread θL1 of the light emitted from the aperture 70a is 60°. And, the lens 90a is designed so as to give properties of collimating such light. As shown in FIG. 8A, in this case, the light emitted from the aperture 70a and passed through the lens 90a become an approximately collimated light, and enters the range of the first pixel 31.

FIG. 8B shows a simulation result when the width 70w of the aperture 70a (the width along the X-axis direction) is 30 μm. Also in the case, the lens 90a is designed so as to give a collimating property. That is, FIG. 8B corresponds to the property of the display device 119d of the ninth comparative example with the aperture ratio of 15% and the angle of spread θL1 of 60°. FIG. 8B shows a simulation result of beams when a point light source with an angle of spread θL1 of 60° is disposed at the center, one end 71a and the other end 71b of the aperture 70a. The drawing corresponds to properties of lights passing through the center, one end 71a and the other end 71b of the aperture 70a in the display device 119d. As shown in FIG. 8B, the light emitted from the center of the aperture 70a and passed through the lens 90a becomes an approximately collimated light and enters the range of the first pixel 31. But, the light passing through one end and the other end of the aperture 70a enters the outside of the range of the first pixel 31. That is, the light emitted from the aperture 70a is not a collimated light but a spread light.

The simulation relates to the case where the aperture ratio is 15%, and, when the aperture ratio is further as large as, for example, 20% or 30%, the phenomena further deteriorates.

In this way, in the case where a lens having a collimating property is used as the lens 90a, when the aperture ratio is small (the case of display device 119a having the aperture ratio of 2% illustrated in FIG. 6, the case of display device 119c having the aperture ratio of 0% illustrated in FIG. 8A, etc.), the light emitted from the aperture 70a can enter the first pixel 31. However, when the aperture ratio is large (for example, cases of the display device 119b illustrated in FIG. 7B and the display device 119d illustrated in FIG. 8B, etc.), the light emitted from the lens 90a is substantially not collimated but becomes a diverging and spread light. Consequently, in a range under a design concept of using a collimating lens, the aperture ratio of the aperture 70a cannot be made large, and thus the efficiency is low.

The use of a lens having a collimating property makes it possible to convert an uncollimated light emitted from a point into a collimate light and to cause the light to enter a pixel, but, when the aperture 70a is broad, an uncollimated light emitted from a plurality of points is emitted toward a pixel as a spread diverging light. Such properties are fundamental properties of lenses of collimating properties. When the distance between the pixel and the lens is short, such diverging light can substantially be kept in the pixel. However, the thickness of a substrate etc. included in the optical switch panel 10 cannot be lessened to a certain value or less, and the distance between the pixel and the lens cannot be set to be a certain value or less. As the result, when a lens of collimating properties is used, it is actually difficult to increase the aperture ratio.

In contrast to this, in display devices 110 and 110a according to the embodiment, for the first light controlling part 91, a lens of imaging properties is used instead of a lens of collimating properties. As the result, as explained regarding FIGS. 4A and 4B, even when the aperture ratio of the first aperture 71 is enlarged up to, for example, 30%, the light emitted from the first light controlling part 91 can enter the range of first pixel 31.

That is, images at one end 71a and the other end 71b of the first aperture 71 can be formed in the first pixel 31. For example, even when the distance between the first light controlling part 91 and the first pixel 31 is long, while corresponding to the distance, it is possible to design the first light controlling part 91 so that the images of the first aperture 71 are formed in the first pixel 31, and, even when the aperture ratio is increased, it is possible to cause the light emitted from the first aperture 71 to enter the first pixel 31. As the result, the aperture ratio can be increased.

As explained previously, even when a lens having imaging properties is used for the first light controlling part 91, in the case where the angle of spread θL1 of a light emitted from the first aperture 71 is too large and the light emitted from the first aperture 71 is not a semi-collimated light (for example, the case of the display device 119 of the fifth comparative example illustrated in FIG. 5), the color mixture is generated.

Accordingly, in the display device 110 according to the embodiment, the combination of the use of a lens having imaging properties for the first light controlling part 91, and the semi-collimation of the light omitted from the first aperture 71, even when the aperture ratio of the first aperture 71 is made large, a display device with suppressed color mixture, with high efficiency and with low power consumption can be provided.

And, in order to semi-collimate the light emitted from the first aperture 71, in the light source device 50, the reflecting part 53 is set to be specularly reflective, a directive LED or the like is used as the light source 60 to be used, and a source light Ls of semi-collimated light is used. That is, through the use of the angle of spread θL1 described regarding FIGS. 2A to 2C, the angle of spread θL1 of the source light Ls is desirably not more than 90°.

In the display devices 110 and 110a according to the embodiment, since a lens having imaging properties is used for the first to third light controlling parts 91 to 93, when respective intervals between the first to third light controlling parts 91 to 93 and the optical switch parts (the first to third liquid crystal layers 21a to 23a) of the first to third pixels 31 to 33 are excessively separated, images of the first to third apertures 71 to 73 are projected in a range larger than the range of the first to third pixels 31 to 33 (for example, the range along the X-axis direction).

For example, in FIGS. 4A and 4B, when the position of the first liquid crystal layer 21a is apart from the first light controlling part 91 along the Z-axis direction, an imaging light emitted from the first light controlling part 91 enters another pixel adjacent to the first pixel 31 to generate the color mixture.

Therefore, the position of the first liquid crystal layer 21a along the Z-axis direction is disposed so as to be close to the first light controlling part 91 to a certain or smaller level.

That is, the distance between the first liquid crystal layer 21a and the first light controlling part 91 is set to be not more than the distance between the position at which the image of the first aperture 71 is formed by the first light controlling part 91 and the first light controlling part 91. In the same manner, the distance between the second liquid crystal layer 22a and the second light controlling part 92 is set to be not more than the distance between the position at which the image of the second aperture 72 is formed by the second light controlling part 92 and the second light controlling part 92. And, the distance between the third liquid crystal layer 23a and the third light controlling part 93 is set to be not more than the distance between the position at which the image of the third aperture 73 is formed by the third light controlling part 93 and the third light controlling part 93. As the result, the color mixture can be suppressed.

In the display devices 110 and 110a according to the embodiment, the interference filter can be formed by holography, in addition to a forming method of stacking dielectric films. The use of such method enables the interference filter to be manufactured with high productivity and low cost, thereby reducing the cost of the display device.

The first light controlling part 91, the second light controlling part 92 and the third light controlling part 93 can be set to lenses independent from one another, or be set to a cylindrical lens in which each of these is continued. In the case of the cylindrical lens, when denoting the direction in which the first light controlling part 91, the second light controlling part 92 and the third light controlling part 93 contact each other by an X-axis direction, the extending direction of the cylindrical lens can be set to be a Y-axis direction that is perpendicular to the Z-axis direction and the X-axis direction.

In the display devices 110 and 110a, as compared with the third and fourth comparative examples, the efficiency is enhanced by reducing the loss of light on the light path between the first to third interference filters 81 to 83 and the reflecting part 53. On the light path, it is more desirable not to place as far as possible, for example, a boundary of media having refractive indices different from each other. And, on the light path, it is more desirable not to place as far as possible a member that absorbs light.

In the display devices 110 and 110a, on the light path between the first to third interference filters 81 to 83 and the reflecting part 53, the light guiding region 52 is provided. The light guiding region 52 more desirably does not include a boundary of media having refractive indices different from each other, and a member that absorbs lights. For example, a form, in which the light source device 50 has the casing 51a having the cavity 52a in the inside thereof and the light guiding region 52 is the region of the cavity 52a (the air), is one of desirable forms. For example, the light guiding region 52 is filled with the air.

For example, by depositing, for example, silver at a thickness of 20 μm to 200 μm for the inner wall 53a of the casing 51a as a reflection film, the reflecting part 53 can be formed. As the result, the reflecting part 53 can be made nondiffusible.

As described later, when the optical switch panel 10 is a liquid crystal panel, the optical switch panel 10 often has a polarizing sheet (a polarizing filter), and, in such case, by setting the light emitted from the light source device 50 (for example, first to third lights L1 to L3) to be a polarized light, the whole efficiency is enhanced. In this case, as described later, the light guiding region 52 may have, for example, a reflection polarizing sheet.

And, for example, a plate-like light guiding unit material of glass or acrylic having a high transmittance may be used as the light guiding region 52. In this case, such structure can be adopted, in which the light source 60 is disposed so that the source light Ls enters the light guiding unit material, and that the reflecting part 53 is provided excluding first to third apertures 71 to 73 so as to surround the outer wall of the light guiding unit material. In this case, when compared with the case where the light guiding region 52 is the cavity 52a inside the casing 51a, the efficiency lowers because of the light absorption etc. in the light guiding unit material, but by raising the transmittance of a material for use in the light guiding unit material, a practically sufficiently high efficiency can be obtained.

The first to third apertures 71 to 73 can have various shapes such as mutually independent circles, flat circles, rectangles, rectangles with rounded corner parts, shapes obtained by combining a plurality of rectangles. And, each of the first to third apertures 71 to 73 may have a plurality of sub-apertures.

At least any of the first to third apertures 71 to 73 may have, for example, a slit-like shape extending in the Y-axis direction.

The size and shape of the first to third apertures 71 to 73 (the size and shape viewed from the Z-axis direction) may be different from each other.

But, the pattern of the first to third apertures 71 to 73 viewed from the Z-axis direction is desirably set to be smaller than the pattern of the first to third pixels 31 to 33 viewed from the Z-axis direction. In other words, desirably, the size of the first aperture 71 is smaller than the size of the first pixel 31, the size of the second aperture 72 is smaller than the size of the second pixel 32, and the size of the third aperture 73 is smaller than the size of the third pixel 33.

If patterns of the first to third apertures 71 to 73 viewed from the Z-axis direction are not smaller than patterns of the first to third pixels 31 to 33 viewed from the Z-axis direction, there is such a possibility that a part of lights emitted from the first to third apertures 71 to 73 enters ranges excluding corresponding first to third pixels 31 to 33, respectively, to generate, for example, leak of the light, the color mixture or loss of the light. By setting patterns of the first to third apertures 71 to 73 viewed from the Z-axis direction to be smaller than patterns of the first to third pixels 31 to 33 viewed from the Z-axis direction, respectively, the leak of the light, the color mixture, and the loss of the light can be suppressed.

In the display devices 110 and 110a according to the embodiment, for example, the second pixel 32 is disposed adjacent to the first pixel 31 along the X-axis direction, the third pixel 33 is disposed, for example, adjacent to the second pixel 32 along the X-axis direction on the side opposite to the first pixel 31 of the second pixel 32. The first to third pixels 31 to 33 are set to be one display element, and a plurality of display elements are provided repeatedly along the X-axis direction. And, a plurality of display elements standing in a line in the X-axis direction are provided in a plurality of numbers along the Y-axis direction.

That is, in the optical switch panel 10, a plurality of display elements are provided in a matrix along the X-axis direction and the Y-axis direction, and each of a plurality of display elements has the first to third pixels 31 to 33. For example, the first to third pixels 31 to 33 may be provided adjacent in each of the pairs along the Y-axis direction. In this case, the first to third pixels 31 to 33 are provided in a matrix in a stripe array. And, for example, the second pixel 32 or the third pixel 33 may be provided adjacent to the first pixel 31 along the Y-axis direction. Moreover, for example, the disposition place of each of the first to third pixels 31 to 33 may be shifted, for example, in every one half of respective disposition pitches of the first to third pixels 31 to 33 along the Y-axis direction.

Respective positions of the first to third apertures 71 to 73, the first to third interference filters 81 to 83, and the first to third light controlling parts 91 to 93 along the X-axis direction correspond to respective positions of the first to third pixels 31 to 33 along the X-axis direction. While corresponding to disposed positions of the first to third pixels 31 to 33 in an X-Y plane, respective disposed positions of the first to third apertures 71 to 73, the first to third interference filters 81 to 83 and the first to third light controlling parts 91 to 93 in the X-Y plane are linked together.

In the above description, the case where one display element includes the first to third pixels 31 to 33, but the number of pixels included in one display element is arbitrary.

For example, one display element may have the first pixel 31 and the second pixel 32, and, in this case, for the light source device 50, the first aperture 71, the second aperture 72, the first interference filter 81, the second interference filter 82, the first light controlling part 91 and the second light controlling part 92 are provided. And, one display element may have three pixels or more.

For example, one display element may have a fourth pixel in addition to the first pixel 31, the second pixel 32 and the third pixel 33. In this case, for the light source device 50, a fourth aperture, a fourth interference filter and a fourth light controlling part are furthermore provided in addition to the first to third apertures 71 to 73, the first to third interference filters 81 to 83 and the first to third light controlling parts 91 to 93. The fourth interference filter causes a light in a fourth wavelength dand of a wavelength dand different from the first to third wavelength dands to pass, and reflects lights in wavelength dands excluding the fourth wavelength dand. The transmittance of the fourth interference filter to the light in the fourth wavelength dand is higher than the transmittance to lights in wavelength dands excluding the fourth wavelength dand, and the reflectance of the fourth interference filter to the light in the fourth wavelength dand is lower than the reflectance to lights in wavelength dands excluding the fourth wavelength dand. For example, the first wavelength dand of the first interference filter 81 is a red wavelength dand, the second wavelength dand of the second interference filter 82 is a first green wavelength dand, the third wavelength dand is a blue wavelength dand, and the fourth wavelength dand is a second green wavelength dand having properties different from the properties of the second wavelength dand. As the result, display of a higher color rendering index can be performed.

In this way, the number of types of pixels provided on the optical switch panel 10 (the number of pixels that are owned by one display element) is arbitrary. And, the number of types of interference filters provided in the light source device 50 is arbitrary. But, the number of types of pixels provided on the optical switch panel 10 is equal to the number of types of interference filters provided for the light source device 50.

### Second Embodiment

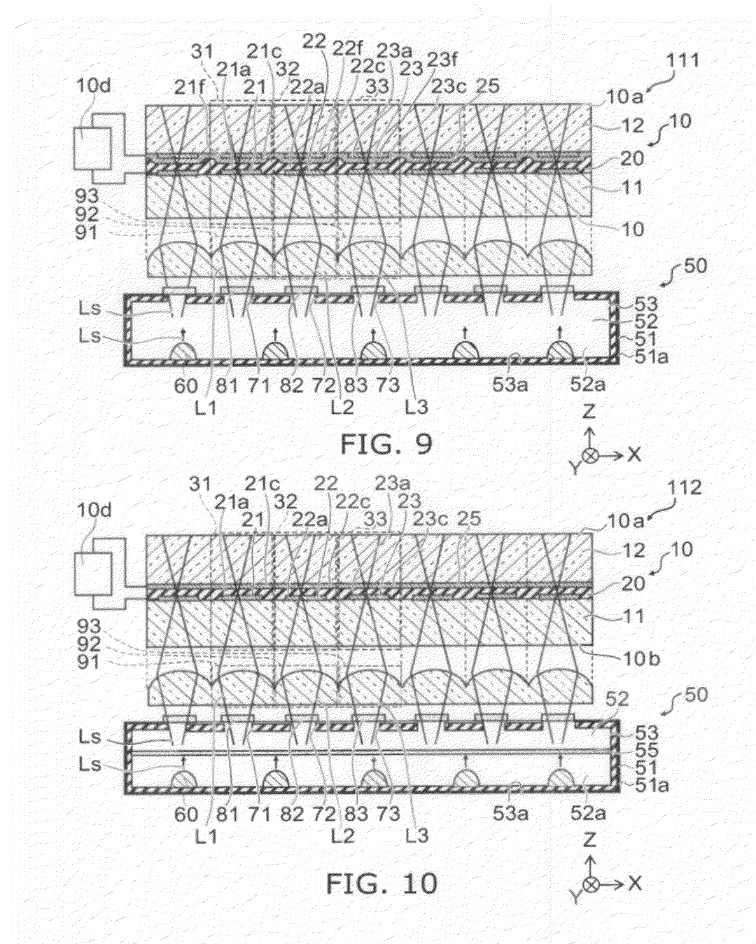

FIG. 9 is a schematic cross-sectional view illustrating the configuration of a display device according to a second embodiment of the invention.

As shown in FIG. 9, in a display device 111 according to the second embodiment of the invention, on the second substrate 12 of the optical switch panel 10, absorption type color filters (a first, second, and third absorption filters 21f, 22f and 23f) are provided. That is, the first pixel 31 has the first absorption filter 21f absorbing lights in wavelength dands excluding the first wavelength dand. The second pixel 32 has the second absorption filter 22f absorbing lights in wavelength dands excluding the second wavelength dand. And the third pixel 33 has the third absorption filter 23f absorbing lights in wavelength dands excluding the third wavelength dand.

An absorptivity of the first absorption filter 21f to lights in wavelength dands excluding the first wavelength dand is higher than the absorptivity to the light in the first wavelength dand. The absorptivity of the second absorption filter 23f to lights in wavelength dands excluding the second wavelength dand is higher than the absorptivity to the light in the second wavelength dand. The absorptivity of the third absorption filter 23f to lights in wavelength dands excluding the third wavelength dand is higher than the absorptivity to the light in the third wavelength dand.

In the specific example, each of the first to third absorption filters 21f to 23f is disposed opposite to each other of the first to third interference filters 81 to 83 of the first to third liquid crystal layers 21a to 23a (for example, on the side of the second substrate 12), but each of the first to third absorption filters 21f to 23f may be disposed on the side of the first to third interference filters 81 to 83 of the first to third liquid crystal layers 21a to 23a (for example, on the side of the first substrate 11).

For example, when lights enter obliquely each of the first to third interference filters 81 to 83, wavelengths (wavelength dands) of lights passing through the first to third interference filters 81 to 83 may shift, for example, to a shorter wavelength side relative to lights entering the filters from the front to lower color purity of display. On this occasion, as the display device 111, by providing further an absorption type color filter for each of pixels, the lowering of the color purity can be suppressed and display with high color purity can be provided.

When a stacked film of dielectric films is used as the first to third interference filters 81 to 83, the number of dielectric films to be stacked is sometimes made large in order to control optical properties (transmission/reflection properties) of the first to third interference filters 81 to 83 with high accuracy. When the number of dielectric films to be stacked is made larger, the productivity of the first to third interference filters 81 to 83 lowers, but by the combined use of the first to third interference filters 81 to 83 and the first to third absorption filters 21f to 23f, a requirement for steepness in wavelength dependency of transmission/reflection properties of the first to third interference filters 81 to 83 is loosened. That is, the light of unnecessary wavelengths being generated when the wavelength dependency of transmission/reflection properties of the first to third interference filters 81 to 83 is not steep can be removed by each of absorption filters. As the result, it is possible to loosen required specifications of the first to third interference filters 81 to 83 and lower the manufacturing cost.

In this way, in the optical switch panel 10 (for example, liquid crystal panel) having such absorption filters as the first to third absorption filters 21f to 23f, in each of the first to third absorption filters 21f to 23f, lights in wavelength dands excluding first to third wavelength dands are absorbed. But, the intensity of lights in wavelength dands excluding the first to third wavelength dands arriving at each of the first to third absorption filters 21f to 23f is lowered by the first to third interference filters 81 to 83, the loss of lights absorbed by the first to third absorption filters 21f to 23f is not large. As the result, the lowering of the efficiency, when the first to third absorption filters 21f to 23f are used, is scarcely generated.

In the specific example, all the first to third absorption filters 21f to 23f are provided at the same time, but it is sufficient to provide at least any of the first to third absorption filters 21f to 23f. That is, it is sufficient that at least any of the following is satisfied: the first pixel 31 further has the first absorption filter 21f absorbing lights in wavelength dands excluding the first wavelength dand, the second pixel 32 further has the second absorption filter 22f absorbing lights in wavelength dands excluding the second wavelength dand, and the third pixel 33 further has the third absorption filter 23f absorbing lights in wavelength dands excluding the third wavelength dand.

### Third Embodiment

FIG. 10 is a schematic cross-sectional view illustrating the configuration of a display device according to a third embodiment of the invention.

The drawing is a schematic cross-sectional view illustrating the configuration of a display device 112 according to the embodiment.

As shown in FIG. 10, in the display device 112 according to the embodiment, the light source device 50 further has a diffusion sheet 55 provided in the light guiding region 52. The diffusion sheet 55 is provided between the light source 60 and first to third apertures 71 to 73. The diffusion sheet 55 controls a diffusion angle of the light entering the diffusion sheet 55 and causes the light to be emitted from the diffusion sheet 55. Except for this, the device 112 can be the same as the display device 110 and the explanation will be omitted.

When a light source with an extremely high directivity (for example, a directional LED) is used as the light source 60, unevenness in the intensity of light may be generated in the light guiding region 52 (for example, the cavity 52a inside the casing 51a), but, like in the case of the display device 112, by providing the diffusion sheet 55 between the light source 60 of the light guiding region 52 and the first to third apertures 71 to 73, it is possible to suppress the unevenness and to uniformize the intensity of the light.

The diffusion sheet 55 broadens the angle of spread θL1 of the source light Ls emitted, for example, from a plurality of directional LEDs used as the light source 60. As the result, the distribution of the light intensity can be uniformized.

The optical properties of the diffusion sheet 55 and the arrangement of the diffusion sheet 55 are set so that the light passed through the diffusion sheet 55 is emitted from the first to third apertures 71 to 73, and lights emitted from the first to third apertures 71 to 73 enter each of the first to third light controlling parts 91 to 93. Accordingly, as the diffusion sheet 55, it is desirable that, for example, a diffusion sheet having random irregularities on the surface, a diffusion sheet having fine particles in the inside, or the like is not to be used, but that a lens sheet having controlled irregularities on the surface is to be used in order to control optical properties. As the result, the broadening angle of the light passing through the diffusion sheet 55 is controlled appropriately, and the light passed through the diffusion sheet 55 is emitted from the first to third apertures 71 to 73, and enters each of the first to third light controlling parts 91 to 93.

In the specific example, the diffusion sheet 55 is provided inside the light guiding region 52, and, when the light is multiple-reflected between the reflecting parts 53 themselves in the light source device 50, the light passes through the diffusion sheet 55 in multiple times. In order to suppress the loss when the light passes through the diffusion sheet 55, the transmittance of the diffusion sheet 55 (the transmittance when the light passes once through the diffusion sheet 55) is desirably set to be around 95% or more. As the result, the lowering of the efficiency caused by the provision of the diffusion sheet 55 can be suppressed.

Meanwhile, as the diffusion sheet 55, for example, a lens diffusion sheet (LSD: Light Shaping Diffusers) of Luminit, Limited Liability Partnership may be used.

### Fourth Embodiment

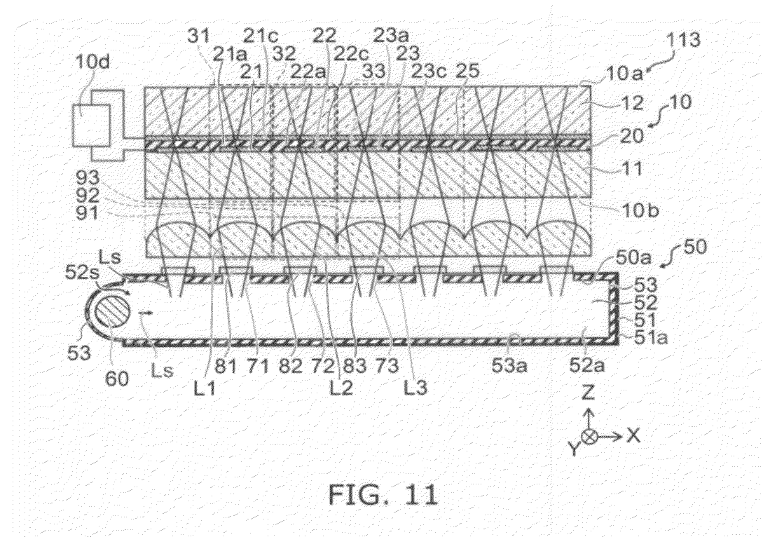

FIG. 11 is a schematic cross-sectional view illustrating the configuration of a display device according to a fourth embodiment of the invention.

As shown in FIG. 11, in a display device 113 according to the embodiment, the light guiding unit 51 has the casing 51a having the cavity 52a in the inside, the light guiding region 52 includes a region of the cavity 52a, the light source 60 is provided at the side part intersecting with the major surface 50a on which the first aperture 71 of the casing 51a is provided, and the reflecting part 53 is provided so as to surround the periphery of the light source 60, along the inner wall 53a surrounding the cavity 52a.

In this way, the light source 60 is provided on the side face 52s of the light guiding region 52, and the light source device 50 may be of a side light type. For example, the light source 60 faces the light guiding region 52s in a direction parallel to the rear face 20b of the switch panel 10. That is, the light source 60 faces the light guiding region 52s in a direction parallel to a plane including the first pixel 31 and the second pixel 32.

Also in this case, the source light Ls emitted from the light source 60 is reflected by the light guiding region 52 of the cavity 52a inside the casing 51a, lights in the first to third wavelength dands (first to third lights L1 to L3) are emitted from the first to third interference filters 81 to 83 to enter the first to third pixels 31 to 33.

In this way, also in the display device 113, a display device having suppressed color mixture, and being capable of display with low power consumption can be provided.

### Fifth Embodiment

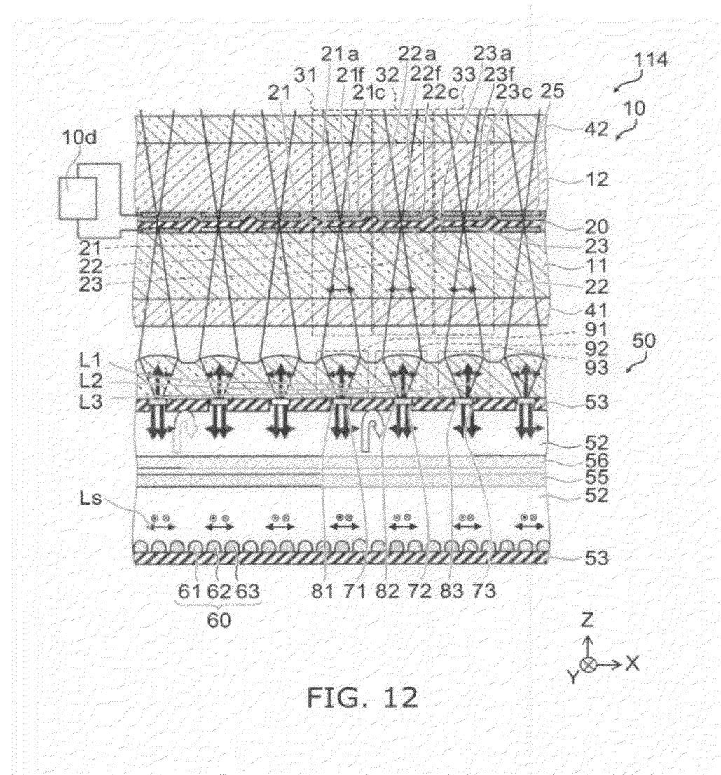

FIG. 12 is a schematic cross-sectional view illustrating the configuration of a display device according to a fifth embodiment of the invention.

As shown in FIG. 12, in a display device 114 according to the embodiment, on the side opposite from the liquid crystal layer 20 of the first substrate 11 of the optical switch panel 10, and on the side opposite from the liquid crystal layer 20 of the second substrate 12, a first polarizing sheet 41 and a second polarizing sheet 42, respectively, are provided. For example, the direction of polarizing light of the first polarizing sheet 41 and the direction of polarizing light of the second polarizing sheet 42 is substantially perpendicular to each other, or is substantially parallel to each other.

Moreover, on the first to third pixels 31 to 33 of the optical switch panel 10, first to third absorption filters 21f to 23f are provided, respectively. The optical switch panel 10 is, for example, a liquid crystal panel of a transmissive active matrix drive system.

And, in the light source device 50, the light source 60 includes a first light source 61 emitting a light of a wavelength including the first wavelength dand, a second light source 62 emitting a light of a wavelength including the second wavelength dand, and a third light source 63 emitting a light of a wavelength including the third wavelength dand. The first to third light sources 61 to 63 are repeatedly provided in a plurality of numbers along the X-axis direction (and the Y-axis direction).

The light source device 50 further has a polarizing reflection sheet 56 provided between the light source 60 and the first interference filter 81 (and the second interference filter 82 and the third interference filter 83). In the specific example, the polarizing reflection sheet 56 is provided in the light guiding region 52. The polarizing reflection sheet 56 causes a polarized light of one direction to pass, and reflects polarized lights of directions excluding the one direction. For example, among lights having entered the polarizing reflection sheet 56, for example, the polarized light in the X-axis direction passes through the polarizing reflection sheet 56, and polarized lights of directions excluding the X-axis direction are reflected by the polarizing reflection sheet 56 and proceed toward the reflecting part 53.

In the specific example, between the light source 60 and the first interference filter 81 (and the second interference filter 82 and the third interference filter 83), further, the diffusion sheet 55 is provided. Meanwhile, in the case where the polarizing reflection sheet 56 is provided, the diffusion sheet 55 may be omitted.

That is, the light source device 50 may further have at least one of the polarizing reflection sheet 56 which is provided between the light source 60 and the first interference filter 81 (and the second interference filter 82 and the third interference filter 83) and causes a polarized light of one direction to pass and reflects polarized lights of directions excluding the one direction, and the diffusion sheet 55 which is provided between the light source 60 and the first interference filter 81 (and the second interference filter 82 and the third interference filter 83) and controls the diffusion angle of lights emitting from the diffusion sheet 55.

The polarization direction of a light allowed to pass through the first polarizing sheet 41 of the optical switch panel 10 and the polarization direction of a light allowed to pass through the polarizing reflection sheet 56 are set to be substantially parallel to each other. For example, when the polarization direction of a light allowed to pass through the first polarizing sheet 41 is 45° relative to the X-axis direction, the polarization direction of a light allowed to pass through the polarizing reflection sheet 56 is defined as 45° relative to the X-axis direction.

In the specific example, for making the explanation simple, a case where the direction allowed to pass through the first polarizing sheet 41 is the X-axis direction will be explained. In this case, the direction allowed to pass through the polarizing reflection sheet 56 is defined as the X-axis direction.

When the light emitted from the light source 60 passes through the diffusion sheet 55 and enters the polarizing reflection sheet 56, for example, a polarized light in the X-axis direction passes and goes toward the first to third apertures 71 to 73. And, for example, a polarized light in the Y-axis direction is reflected by the polarizing reflection sheet 56, goes toward the reflecting part 53, and is reflected by the reflecting part 53. In the reflection by the reflecting part 53, the polarization state of the light changes, and the light passes again through the diffusion sheet 55 to enter the polarizing reflection sheet 56. And, the light having the polarization in the X-axis direction, of the light having entered again the polarizing reflection sheet 56 passes, and a light having the polarization in the Y-axis direction is reflected by the polarizing reflection sheet 56. Afterward, the operation is repeated.

The repetition makes it possible to put polarization of source light Ls emitted from the light source 60 in order in an intended direction by the polarizing reflection sheet 56, and to cause the light to be emitted from the polarizing reflection sheet 56. As the result, a polarized light in a direction allowed to pass through the first polarizing sheet 41 enters the first polarizing sheet 41 of the optical switch panel 10, to suppress the loss of light in the first polarizing sheet 41.

As the polarizing reflection sheet 56, DBEF of Sumitomo 3M Ltd. can be used.

Moreover, in the specific example, between the polarizing reflection sheet 56 and the light source 60, the diffusion sheet 55 controlling the diffusion angle of a light emitted from the diffusion sheet 55 is provided. As the diffusion sheet 55, a prism sheet, a diffusion lens sheet etc. can be used. The diffusion sheet 55 can have such function as canceling the polarized direction of the polarized light reflected by the polarizing reflection sheet 56, and, by utilizing effectively not only the reflecting part 53 but also the function of canceling the polarized light in the diffusion sheet 55, the efficiency can be further improved.

### Sixth Embodiment

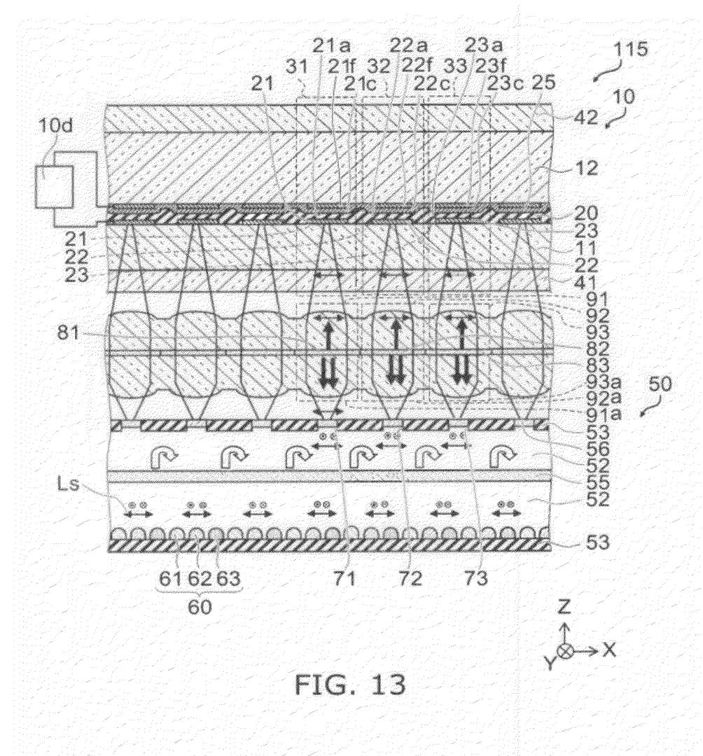

FIG. 13 is a schematic cross-sectional view illustrating the configuration of a display device according to a sixth embodiment of the invention.

As shown in FIG. 13, in a display device 115 according to the embodiment, the polarizing reflection sheet 56 provided in the light guiding region 52 in the display device 114 is provided in each of the first to third apertures 71 to 73. Furthermore, in each of between respective first to third apertures 71 to 73 and respective first to third interference filters 81 to 83, first to third incident side light controlling parts 91a to 93a are further provided. Except for this, the device 115 is the same as the display device 114.

That is, in the display device 115, between respective first to third light controlling parts 91 to 93 and respective first to third incident side light controlling parts 91a to 93a, the first to third interference filters 81 to 83 are provided. The light emitted from each of the first to third apertures 71 to 73 becomes an approximately parallel light (a light proceeding in a direction parallel to the Z-axis direction) by the first to third incident side light controlling parts 91a to 93a. As the result, the light enters approximately perpendicularly the first to third interference filters 81 to 83. And, the light in the first to third wavelength dands, of the light having entered the first to third interference filters 81 to 83, enters the first to third pixels 31 to 33 by the first to third light controlling parts 91 to 93. And, each of lights in wavelength dands excluding the first to third wavelength dands is reflected in an approximately vertical direction by the first to third interference filters 81 to 83.

When the polarizing reflection sheet 56 is provided in the first to third apertures 71 to 73, there is a case where the distance between the first to third interference filters 81 to 83 and the first to third apertures 71 to 72, respectively, is set to be comparatively large in order to make the distribution of light intensities uniform. In this case, since the directivity of lights emitted from the first to third apertures 71 to 73 is relatively low, and the lights proceed while spreading, the ratio of lights entering the first to third interference filters 81 to 83 from oblique directions is raised. When lights enters the first to third interference filters 81 to 83 from oblique directions, wavelength dands passing through each of the first to third interference filters 81 to 83 shift to a short wavelength direction, and, the ratio of the light returning to the light guiding region 52 from the first to third apertures 71 to 73, to the light reflected by the first to third interference filters 81 to 83, lowers and the efficiency lowers.

On this occasion, in the display device 115 of the embodiment, by providing the first to third interference filters 81 to 83 between respective first to third light controlling parts 91 to 93 and respective first to third incident side light controlling parts 91a to 93a, it is possible to suppress the shift of the wavelength dand in a short wavelength direction to deter the variation of displaying colors, and, to return, with high efficiency, lights reflected from the first to third interference filters 81 to 83 to the light guiding region 52 from the first to third apertures 71 to 73, thereby suppressing the lowering of the efficiency.

In this way, in the display device 115, by using two lens arrays (the first to third light controlling parts 91 to 93 and the first to third incident side light controlling parts 91a to 93a), even when the first to third interference filters 81 to 83 are apart from the first to third apertures 71 to 73, the variation of display colors is suppressed and a high efficiency is obtained.

In the display device 115, the first to third light controlling parts 91 to 93 are lenses substantially flat on the side of the first to third interference filters 81 to 83 and convex on the side opposite to the first to third interference filters 81 to 83, and the first to third incident side light controlling parts 91a to 93a are lenses substantially flat on the side of the first to third interference filters 81 to 83 and convex on the side opposite to the first to third interference filters 81 to 83, but the invention is not limited to this. Hereinafter, modified examples of the display device 115 will be explained.

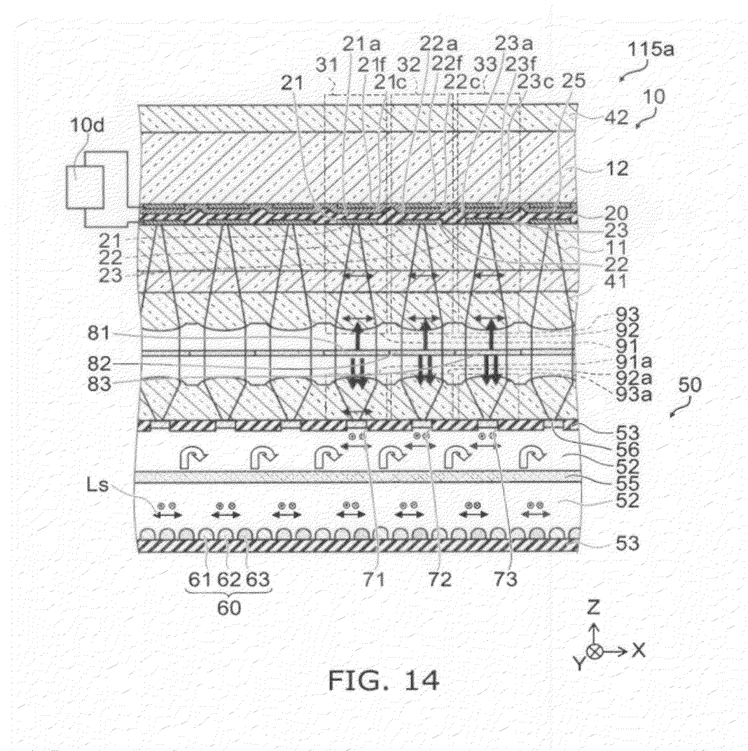

FIG. 14 is a schematic cross-sectional view illustrating the configuration of another display device according to the sixth embodiment of the invention.

As shown in FIG. 14, in another display device 115a according to the embodiment, the first to third light controlling parts 91 to 93 are convex on the side of the first to third interference filters 81 to 83, and are substantially flat on the side opposite to the first to third interference filters 81 to 83. And, the first to third incident side light controlling parts 91a to 93a are convex on the side of the first to third interference filters 81 to 83, and are substantially flat on the side opposite to the first to third interference filters 81 to 83.

In the specific example, the first to third light controlling parts 91 to 93 are close to or are in contact with the optical switch panel 10, and the first to third light controlling parts 91 to 93 and the first to third interference filters 81 to 83 are separated from each other. The first to third incident side light controlling parts 91a to 93a are close to or are in contact with the first to third apertures 71 to 73, and the first to third incident side light controlling parts 91a to 93a and the first to third interference filters 81 to 83 are separated from each other. Except for this, the device 115a is the same as the display device 115.

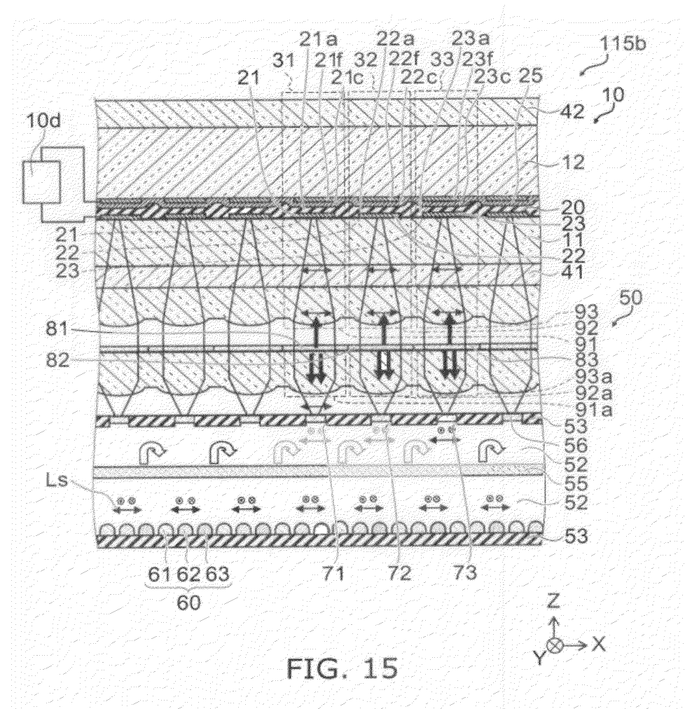

FIG. 15 is a schematic cross-sectional view illustrating the configuration of another display device according to the sixth embodiment of the invention.

As shown in FIG. 15, in another display device 115b according to the embodiment, the first to third light controlling parts 91 to 93 are convex on the side of the first to third interference filters 81 to 83, and are substantially flat on the side opposite to the first to third interference filters 81 to 83. And, the first to third incident side light controlling parts 91a to 93a are substantially flat on the side of the first to third interference filters 81 to 83, and are convex on the side opposite to the first to third interference filters 81 to 83.

In the specific example, the first to third light controlling parts 91 to 93 are close to or are in contact with the optical switch panel 10, and the first to third light controlling parts 91 to 93 and the first to third interference filters 81 to 83 are separated from each other. The first to third incident side light controlling parts 91a to 93a are close to or are in contact with the first to third interference filters 81 to 83, and the first to third incident side light controlling parts 91a to 93a and the first to third apertures 71 to 73 are separated from each other. Except for this, the device 115b is the same as the display device 115.

In this way, the configuration and the arrangement of the first to third light controlling parts 91 to 93, and the first to third incident side light controlling parts 91a to 93a are arbitrary.

Also in the display devices 115a and 115b, a display device having a suppressed color mixture and being capable of performing display with low power consumption can be provided. And, by further providing the first to third incident side light controlling parts 91a to 93a, it is possible to allow a substantially parallel light to enter the first to third interference filters 81 to 83, to suppress the variation of displayed colors, and to realize further high efficiency.

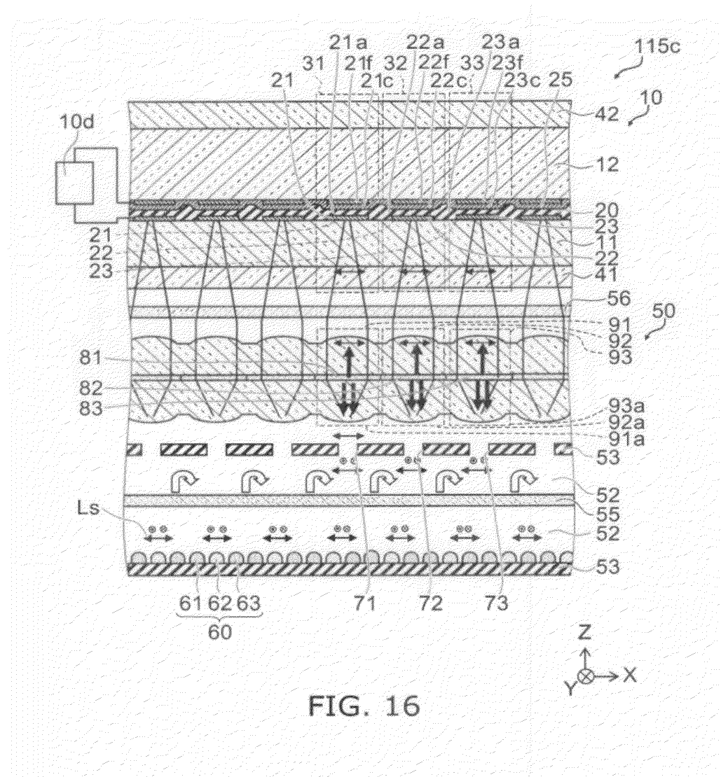

FIG. 16 is a schematic cross-sectional view of the configuration of another display device according to the sixth embodiment of the invention.

As shown in FIG. 16, in another display device 115c according to the embodiment, the polarizing reflection sheet 56 provided in the first to third apertures 71 to 73 in the display device 115, is provided between respective first to third light controlling parts 91 to 93 and respective first to third pixels 31 to 33.

Also in the display device 115c, it is possible to provide a display device having a suppressed color mixture and being capable of performing display with low power consumption.

In this way, in the light source device 50, even when the positional relation between the first to third interference filters 81 to 83 and the polarizing reflection sheet 56 along the Z-axis direction is changed from relations in display devices according to above-mentioned respective embodiments and modified examples, there is substantially no influence on the efficiency of light. Accordingly, positional relations between the first to third interference filters 81 to 83 and the polarizing reflection sheet 56 along the Z-axis direction may be interchangeable, and positional relations are arbitrary.

In this way, the light source device 50 can further have the polarizing reflection sheet 56 which is provided at least either of between the light source 60 and the first interference filter 81 and between the first interference filter 81 and first pixel 31, and which causes a polarized light in one direction to pass and reflects polarized lights in directions excluding the one direction.

### Seventh Embodiment

A light source device according to a seventh embodiment of the invention is a light source device for use in display devices according to the embodiments and modified examples thereof.

That is, as shown in FIG. 1, the light source device 50 according to the embodiment includes the light source 60 emitting the source light Ls, the light guiding unit 51, the first interference filter 81, the first light controlling part 91, the second interference filter 82 and the second light controlling part 92.

The light guiding unit 51 has the light guiding region 52 guiding the source light Ls, the reflecting part 53 which is provided around the light guiding region 52 and reflects the source light Ls toward the light guiding region 52, the first aperture 71 which is provided around the light guiding region 52 and emits a semi-collimated light based on the source light Ls (the first light) toward the outside of the light guiding region 52, and the second aperture 72 which is provided around the light guiding region 52 and emits a semi-collimated light based on the source light Ls (the second light) toward the outside of the light guiding region 52.

The first interference filter 81 causes the light in the first wavelength dand of the light emitted from the first aperture 71 (the first light) to pass, the transmittance of the first interference filter 81 to the light in the first wavelength dand is higher than the transmittance to lights in wavelength dands excluding the first wavelength dand, and the reflectance of the first interference filter 81 to the light in the first wavelength dand is lower than the reflectance to lights in wavelength dands excluding the first wavelength dand.

The first light controlling part 91 causes the light passed though the first interference filter 81 to form an image.

The second interference filter 82 causes the light in the second wavelength dand different from the first wavelength dand of the light emitted from the second aperture 72 (the second light) to pass, the transmittance of the second interference filter 82 to the light in the second wavelength dand is higher than the transmittance to lights in wavelength dands excluding the second wavelength dand, and the reflectance of the second interference filter 82 to the light in the second wavelength dand is lower than the reflectance to lights in wavelength dands excluding the second wavelength dand.

The second light controlling part 92 causes the light passed though the second interference filter 82 to form an image.

As the result, a light source device capable of performing display with high efficiency and low power consumption when combined with the optical switch panel 10 can be realized.

Meanwhile, the light guiding unit 51 can further have the third aperture 73 which is provided around the light guiding region 52, and which emits a semi-collimated light based on the source light Ls (the third light) toward the outside of the light guiding region 52.

And, the light source device 50 can further provided with the third interference filter 83, and the third light controlling part 91.

The third interference filter 83 causes the light in the third wavelength dand different from the first wavelength dand or different from the second wavelength dand of the light emitted from the third aperture 73 (the third light) to pass, the transmittance of the third interference filter 83 to the light in the third wavelength dand is higher than the transmittance to lights in wavelength dands excluding the third wavelength dand, and the reflectance of the third interference filter 83 to the light in the third wavelength dand is lower than the reflectance to lights in wavelength dands excluding the third wavelength dand.

The third light controlling part 93 cause the light passed though the third interference filter 83 to form an image.

As the result, a light source device capable of performing display based on three primary colors and with high efficiency and low power consumption, when combined with the optical switch panel 10, can be realized.

The configuration of the light source device 50 explained regarding any of display devices 111 to 115 and 115a to 115c illustrated in FIGS. 9 to 16 can be applied to the light source device 50 according to the embodiment.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinbefore, while referring to specific examples, embodiments of the invention have been explained. However, the invention is not limited to these specific examples. For example, even if a person skilled in the art has made various changes with respect to the shape, size, material, layout relation etc. of specific configuration of respective elements such as the optical switch panel, the pixel, the pixel electrode, the opposing electrode, the liquid crystal layer, the substrate, the polarizing sheet and the absorption filter, which are included in a display device, and the light source, the light guide region, the reflecting part, the casing, the diffusion sheet, the polarizing reflection sheet, the interference filter, the light controlling part and the incident side light controlling part, which are included in a light source device, as long as a person skilled in the art can carry out the invention in the same manner by appropriately selecting them from the known range and can obtain an equivalent effect, they are included in the range of the invention.

Further, any two or more components of the specific examples may be combined within the extent of technical feasibility and are included in the scope of the invention to the extent that the purport of the invention is included.

Moreover, all display devices and light source devices practicable by an appropriate design modification by one skilled in the art based on the display devices and the light source devices described above as embodiments of the invention also are within the scope of the invention to the extent that the purport of the embodiments of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device comprising:
an optical switch panel including:
a first pixel; and
a second pixel juxtaposed with the first pixel;
a drive part to control transmissivity of the first pixel with respect to a light entering the first pixel and transmissivity of the second pixel with respect to a light entering the second pixel; and
a light source device stacked with the optical switch panel and including:
a light source to emit a source light;
a light guiding unit including:
a light guide region to guide the source light;
a reflecting part provided around the light guide region to reflect the source light toward the light guide region;
a first aperture provided around the light guide region and causing a first light based on the source light to be emitted toward outside of the light guide region, the first light being semi-collimated;
a second aperture provided around the light guide region and causing a second light based on the source light to be emitted toward the outside of the light guide region, the second light being semi-collimated;
a first interference filter to cause a light in a first wavelength dand of the first light emitted from the first aperture to pass the first interference filter, transmittance of the light in the first wavelength dand through the first interference filter being higher than transmittance of a light in a wavelength dand excluding the first wavelength dand, and reflectance of the light in the first wavelength dand of the first interference filter being lower than reflectance of the light in the wavelength dand excluding the first wavelength dand;
a first light controlling part to cause the light passed through the first interference filter to enter the first pixel to form an image;
a second interference filter to cause a light in a second wavelength dand of the second light emitted from the second aperture to pass the second interference filter, the second wavelength dand being different from the first wavelength dand, transmittance of the light in the second wavelength dand through the second interference filter being higher than transmittance of a light in a wavelength dand excluding the second wavelength dand, and reflectance of the light in the second wavelength dand of the second interference filter being lower than reflectance of the light in the wavelength dand excluding the second wavelength dand; and
a second light controlling part to cause the light passed through the second interference filter to enter the second pixel to form an image.

2. The device according to claim 1, wherein
the optical switch panel further includes a third pixel juxtaposed with the first pixel and the second pixel,
the drive part further controls transmissivity of the third pixel with respect to a light entering the third pixel,
the light guiding unit further includes a third aperture provided around the light guide region tp cause a third light based on the source light to be emitted toward outside of the light guide region, the third light being semi-collimated,
the light source device further includes:
a third interference filter to cause a light in a third wavelength dand of the third light emitted from the third aperture to pass the third interference filter, the third wavelength dand being different from the first wavelength dand and different from the second wavelength dand, transmittance of the light in the third wavelength dand through the third interference filter is higher than transmittance of a light in a wavelength dand excluding the third wavelength dand, and reflectance of the light in the third wavelength dand of the third interference filter is lower than reflectance of the light in the wavelength dand excluding the third wavelength dand; and
a third light controlling part to cause the light passed through the third interference filter to enter the third pixel to form an image.

3. The device according to claim 2, wherein the reflecting part has specular reflection properties and the source light is semi-collimated.

4. The device according to claim 3, wherein,
the first wavelength dand is a red wavelength dand,
the second wavelength dand is a green wavelength dand, and
the third wavelength dand is a blue wavelength dand.

5. The device according to claim 4, wherein,
the first pixel includes
a first pixel electrode,
a first opposing electrode, and
a first liquid crystal layer provided between the first pixel electrode and the first opposing electrode,
the second pixel includes
a second pixel electrode,
a second opposing electrode, and
a second liquid crystal layer provided between the second pixel electrode and the second opposing electrode, and
the third pixel includes
a third pixel electrode,
a third opposing electrode, and
a third liquid crystal layer provided between the third pixel electrode and the third opposing electrode.

6. The device according to claim 5, wherein
a distance between the first liquid crystal layer and the first light controlling part is not more than a distance between the first light controlling part and a position at which an image of the first aperture is formed by the first light controlling part,
a distance between the second liquid crystal layer and the second light controlling part is not more than a distance between the second light controlling part and a position at which an image of the second aperture is formed by the second light controlling part, and
a distance between the third liquid crystal layer and the third light controlling part is not more than a distance between the third light controlling part and a position at which an image of the third aperture is formed by the third light controlling part.

7. The device according to claim 6, wherein at least one of followings is satisfied,
the first pixel further includes a first absorption filter absorbing the light in the wavelength dand excluding the first wavelength dand,
the second pixel further includes a second absorption filter absorbing the light in the wavelength dand excluding the second wavelength dand, and
the third pixel further includes a third absorption filter absorbing the light in the wavelength dand excluding the third wavelength dand.

8. The device according to claim 7, wherein
the light guiding unit includes a casing provided with a cavity,
the light guide region includes a region of the cavity,
the light source is provided inside of the casing, and
the reflecting part is provided along at least a position of an inner wall position surrounding the cavity and an outer wall position of the casing.

9. The device according to claim 8, wherein the light source device further includes at least one of
a polarizing reflection sheet provided at least one of a position between the light source and the first interference filter and a position between the first interference filter and the first pixel, the polarizing reflection sheet causing a polarized light in one direction to pass the polarizing reflection sheetm the polarizing reflection sheet reflecting a polarized light in a direction excluding the one direction, and
a diffusion sheet provided between the light source and the first interference filter and controlling a diffusion angle of an incident light into the diffusion sheet to cause the incident light to be emitted from the diffusion sheet.

10. The device according to claim 8, wherein the light guiding unit has a major surface on which the first aperture, the second aperture and third aperture are provided, and a ratio of the total area of the first aperture, the second aperture and the third aperture relative to the area of the major surface is not less than 10%.

11. The device according to claim 10, wherein the ratio is not less than 15%.

12. The device according to claim 10, wherein the ratio is from not less than 25% to not more than 35%.

13. The device according to claim 1, wherein an angle of spread of the first light and an angle of spread of the second light are not more than 90°.

14. The device according to claim 1, wherein an angle of spread of the first light and an angle of spread of the second light are not more than 60°.

15. The device according to claim 1, wherein an angle of spread of the first light and an angle of spread of the second light are not more than 40°.

16. The device according to claim 1, wherein an angle of spread of the source light is not more than 90°.

17. The device according to claim 1, wherein:
a size of the first aperture is smaller than a size of the first pixel; and
a size of the second aperture is smaller than a size of the second pixel.

18. The device according to claim 1, wherein the light guide region is filled with air.

19. The device according to claim 1, wherein the light source faces the light guide region in a direction parallel to a plane including the first pixel and the second pixel.

20. A light source device comprising:
a light source to emit a source light;
a light guiding unit including:
a light guide region to guide the source light;
a reflecting part provided around the light guide region to reflect the source light toward the light guide region;
a first aperture provided around the light guide region and causing a first light based on the source light to be emitted toward outside of the light guide region, the first light being semi-collimated; and
a second aperture provided around the light guide region and causing a second light based on the source light to be emitted toward the outside of the light guide region, the second light being semi-collimated,
a first interference filter to cause a light in a first wavelength dand of the first light emitted from the first aperture to pass the first interference filter, transmittance of the light in the first wavelength dand through the first interference filter being higher than transmittance of a light in a wavelength dand excluding the first wavelength dand, and reflectance of the light in the first wavelength dand of the first interference filter being lower than reflectance of the light in the wavelength dand excluding the first wavelength dand;
a first light controlling part to cause the light passed through the first interference filter to form an image;
the second interference filter causing a light in a second wavelength dand of the second light emitted from the second aperture to pass the second interference filter, the second wavelength dand being different from the first wavelength dand, transmittance of the light in the second wavelength dand through the second interference filter being higher than transmittance of a light in a wavelength dand excluding the second wavelength dand, and reflectance of the light in the second wavelength dand of the second interference filter being lower than reflectance of the light in the wavelength dand excluding the second wavelength dand; and
a second light controlling part to cause the light passed through the second interference filter to form an image.
